(19) United States
(12) Patent Application Publication
(10) Pub. No.: US 2009/0193017 A1
(43) Pub. Date: Jul. 30, 2009

(54) Methods and Systems for Corporate Discovery, Investigation, and Implementation of Emerging Technology

(76) Inventor: Kenneth Herrick Sponsel, JR., Lake Oswego, OR (US)

Correspondence Address: BULLIVANT HOUSER BAILEY PC, 1415 L STREET, SUITE 1000, SACRAMENTO, CA, 95814, US

(21) Appl. No.: 12/362,392

(22) Filed: Jan. 29, 2009

Related U.S. Application Data
(60) Provisional application No. 61/024,509, filed on Jan. 29, 2008.

(51) Int. Cl. G06F 17/30; G06Q 10/00; G06Q 99/00

(52) U.S. Cl. 707/5; 707/102; 707/3; 705/7; 705/1; 707/E17.044; 707/E17.014

(57) ABSTRACT

This disclosure provides a system and method of creating a searchable company database, the method comprising the steps of: a) having at least one company enter company information using a user interface; b) creating a company profile database, where the database categorizes the company into a least two tiers of a hierarchical classification system based on the information entered in step a); and c) permitting users to identify a company of interest based on the hierarchical classification system.

### CROSS REFERENCE TO RELATED APPLICATIONS

This application claims priority to, and the benefit of, U.S. Provisional Application No. 61/024,509, filed Jan. 29, 2008 and entitled “Method and System for Discovery and Implementation of Emerging Technologies”, which is hereby incorporated by reference in its entirety.

### BACKGROUND OF THE INVENTION

1. Field of the Invention

This invention describes a method and system for discovering, researching, investigation, purchasing and/or implementing products from emerging technology companies.

2. Description of Related Art

There are problems and challenges for both buyer and seller of emerging technology.

Problems for the Seller: A company established to develop and sell a new and potentially disruptive technology must often sell worldwide, immediately, and early in it's corporate lifespan when it has a very small sales force. The imperative is to spend time and travel only with customers who are likely to buy, and avoid customers who are simply kicking tires. But, how does a new firm with a new sales force and no customer relationships decide which customers to call on?

Problems for the Customer: Customers implement emerging technology either to reduce operating costs or to improve and differentiate their services. Implementing a single, small change can be compelling. For example, the first airline to introduce web check-in enjoyed immediately improved customer retention as a result. Because at any given time there are thousands of emerging technology companies new to the market, it is difficult for any enterprise to keep itself fully informed. The ideal state—maintaining perpetual awareness and synthesis of emerging technologies that might be of use to an enterprise—requires perpetual executive attention as well as skilled staff and expensive resources and methods. Generally, this is practicable only for the Global 50, leaving the remaining corporate enterprises consigned to hit-and-miss decisions based fractional awareness.

The general pattern for acquisition of new technology by a large enterprise is that a single business unit manager, who is experiencing a problem or seeks a competitive advantage, does independent research to find a solution. Or, the astute seller who understands the problem seeks out this manager, knowing that this is where the motivation and budget reside to buy his product.

This causes a problem. Even in mid-size businesses, even if this motivated manager has the budget to buy the technology solution, he does not have the ability on his own to implement it. Example: if a telephone marketing vice president wants to introduce a new subscriber service, he must secure an agreement from Engineering to install the new equipment and software. Sales must agree to sell it. Service must agree to service it. And Billing must agree to bill for it. Each of these directorates has already optimized their own processes and systems to do their own—sizable—day-to-day tasks. Therefore, the new disruptive technology will, indeed, be disruptive to them, even if at the same time it might be wildly attractive to subscribers. And therefore, the other directorates usually resist the new idea. This is standard organizational dynamics and applies regardless of product category.

It is not uncommon for the corporate innovator (e.g., the Marketing VP) to discard technology flavor A and repeat the discovery process for technology flavor B before concluding that flavor C has the operating attributes that are minimally disruptive to the other directorates. In such a case, flavor C will be implemented 6 to 18 months later than it would have been had the Customer discovered it first.

Delays of six to eighteen months in introducing new services and methods that promised significant benefit in the first month is a costly problem for both buyer and seller. It's a particular waste of time, money and resources if a customer's competitor introduces a new and improved product or service while redundant investigations are still underway.

The scale of the problem can be more fully appreciated by considering that, for each new technology, between ten and twenty entities are attempting to bring a product to market. It is usually not the case that the buyer will have time and attention available for a full and complete investigation of all of them.

Several large venture capital firms have taken steps to address these problems on behalf of the emerging technology companies within their own investment portfolio. One method involves holding a live event, like a reception or a luncheon. Taken to its ultimate form, the live event model becomes a multi-day meeting conducted annually at a fashionable resort. For example, Kleiner Perkins and Intel Capital each host an annual “CEO Summit” to which they invite buyers and sellers. The budget for a single CEO Summit can be multiple millions of dollars. In the Intel Capital model, the CEOs of its 150 most successful investment companies are invited. Also invited are 150 senior officers from large Intel customers. In addition to stage proceedings and breakouts sessions the program typically offers about 15 hours of informal networking opportunities as well as 3 hours of structured matchmaking. In structured matchmaking each customer is scheduled for 6 brief meetings each with an emerging technology CEO. The meetings are set based on the highest level of mutual attraction. Mutual attraction is determined by having participants access a web listing of corresponding opposite members, and ranking their top picks. The 6 scheduled sessions are conducted concurrently so that, if all 150 customers attended and participated, there would be a scheduling matrix of 900 meetings (150×6 sessions). These meetings are “zero sum” because if A is meeting with B, then A is unavailable to meet with anyone else during that session. The average customer attendee leaves an Intel Capital CEO Summit having identified 6 to 10 emerging technologies he or she would like to investigate further.

The CEO Summit format is potent and delivers benefit to buyer and seller who might otherwise never have met. However, measured against a standard of helping The Global 2000 and mid-size businesses become fully aware of emerging technology options, it has limited efficacy. First, the universe of buyers is limited numerically to represent approximately 100 customer enterprises (due to multiple attendees from some customers). Measured against the Global 2000, and assuming completely new attendees every year, market penetration per year is one-half of one percent. Given the senior positions held by most of the customer attendees, they are subject to executive interruptions and might be compelled to skip the matchmaking meetings at the last minute. This shrinkage can be up to 10%. This means that as many as 100 of the sessions scheduled for emerging tech companies will result in a “no-show” by the assigned customer. In each of these cases, the emerging technology sellers spend a 20-minute session abandoned, while it appears that everyone else is having a meeting. There is a high degree of frustration experienced by emerging technology sellers who find that some of their target customers did not share a degree of mutual attraction sufficient to merit one of the 6 customer sessions.

To illustrate the limitations of current systems, suppose Microsoft or Cisco or Apple attend a live summit as customers. In this case, scores of emerging tech companies will want to meet with them. However, the schedule allows for only 6 Microsoft meetings, meaning that numerous sellers will be frustrated because they will not get equitable exposure. Assuming a 3 to 4 day format means that customer attendees must give over a full week to travel and to attend. Even if each of the approximately 500 worldwide venture capital firms were to conduct an annual CEO Summit (which they do not) then, using this format, it would take more than 10 years for one person per buying company to be exposed to all the technology possibilities. And, as observed earlier, there would be space for less than 1 percent of the Global 2000 (customers) to attend. And, since the venture capital portfolios turn over constantly, each hypothetical customer attendee would only see about a third of the technology companies that actually emerged during the 10 year cycle.

This live format does nothing to address the reality that implementing a corporate solution requires cross-departmental consensus. In fact, many great possibilities discovered at a CEO Summit are lost as the customer attendee gets consumed by daily tasks upon return to the office, or is simply overwhelmed at the task of sharing the discover(ies) with the requisite plurality of cross-departmental colleagues. Additionally, many great possibilities may have been missed at the event if the singular customer attendee was under-informed on the needs and wants of his or her colleagues in other departments.

In an effort to address some of these problems, Intel Capital introduced the Technology Day concept in 2004. Rather than inviting equal numbers of buyers and sellers to a neutral location once per year, the Technology Day brings 10 carefully selected emerging technology companies to the headquarters of a single host-customer. This arrangement is orchestrated uniquely for 50 to 75 customers per year. The senior executives from the host-customer study and rank an Excel worksheet that contains product descriptions for Intel Capital's portfolio. The prioritized worksheet is returned by email, and Intel Capital then extends invitations to emerging technology company presenters. Rather than the short and un-rehearsed encounters, typical of a reception or CEO Summit, the presentations at a Technology Day are about 30 minutes long, and have been customized by the presenters to address the specific needs and wants of each of the customer's relevant departments. These presentations are based on briefings and information provided to the presenters before they travel to the customer site. In the customer audience, rather than just one senior executive, there are (usually) decision makers and recommenders representing all or most of the customer's business units and functional areas.

The advantages of Technology Day include: (A) in this setting, a corporate consensus for in-depth investigation can be reached on the occasion of the seller's first visit to the customer; (B) most of the customer attendees did not have to travel, and; (C) the presenting technology companies are able to scope and qualify the customer opportunity prior to traveling, and can elect not to participate if they believe their chance of success is low.

The Technology Day model is more potent than the reception and CEO Summit models. Yet, measured against the goal of helping the Global 2000 and mid-size companies worldwide maintain an actionable awareness of emerging technology opportunities, the Technology Day falls short. First, doing 50 to 75 Technology Days per year means, again, that less than 1 percent of the Global 2000 can be addressed per year and none of the mid size businesses (with more than 5,000 employees) can be addressed. Alternatively, in order to penetrate the Global 2000 each year it would be necessary to conduct about 8 Technology Days per business day; this would enable just Intel Capital's portfolio of 250 companies to be visible. This would exclude the portfolios of the other 500 venture capital companies, totaling nearly 4,000 emerging tech companies.

Additionally, Intel Capital's use of an Excel file to gather customer prioritization of emerging technology companies limits the customer's ability to collaborate interdepartmentally. This process of circulating an Excel sheet for input from multiple participants is time consuming, logistically challenging, and error-prone. In addition, as a result of this process the selection of presenters at a Technology Day is skewed as it is made solely by a customer core-group. The opportunity is missed to establish engagement and consensus on problems and solutions prior to the Technology Day presentations. This means that some meritorious solutions are never presented because the customer participant who owns the problem was not queried in advance.

There is a problem common to both the reception/summit formats and to the Technology Day format. The problem is that the customer knows that the selection process is derived from only a partial universe of possibilities. Most venture capitalists do not make multiple investments in the same technology. But, for any truly new product or service with large volume potential, there will be between 10 and 20 competitors attempting to bring it to market. Therefore, the prudent customer will expect that a single venture capitalist organizing an event will not have shown him all possible technologies and all possible implementations. As the customer becomes more intentional about discovering and implementing emerging technologies, the customer will form an awareness that there are at any time thousands of new emerging technologies, and that there has not been a broker available to make the sum of possibilities visible in a manner that allows for efficient discovery and investigation. The current invention creates a system where each of the Global 2000, or any consumer of the information, can personally do the work necessary, in perpetuity, to maintain their own proprietary indexes archiving investigations of several thousand emerging technology companies.

Currently there is no expeditious and direct method to survey the world's supply of several thousand emerging technology companies. Only a handful of venture capitalists have made their own portfolios of a few hundred companies visible in manner that allows for comparative study and prioritization. And, none of these offer a method or system that allows for the collaboration necessary to identify technologies for which there exists a customer's cross-departmental consensus to explore implementation.

### SUMMARY OF THE INVENTION

This invention provides a database (e.g., catalog or register) containing congruent and sortable web profiles of nearly all emerging technologies, representing the investments of over 500 venture capitalists as well as, private equity firms, governmental agencies, privately funded start ups, and open-market inventions of Global 2000 companies. This invention is not limited to these enumerated categories of users and has wide applicability in a variety of fields.

The invention includes multiple tools and methods for an individual user to search, prioritize, and log his observations. It also enables enterprise decision teams to form spontaneously or by executive mandate. These teams are provided tools for on-line dialogue and consensus. Finally, the invention includes a method for the potential customer to contact the seller in a systematic manner that allows for immediate pre-qualification of the opportunity so that neither the buyer or seller waste time and effort in the case that there is not an workable application of the technology to the customer's problem

While one embodiment of the invention applies to emerging technology companies, the invention described can also be used by individuals and groups to search, evaluate, and make decisions applied to databases containing wide and varied ranges of products, services, companies and associations, and not necessarily limited only to a database of emerging technology companies.

This disclosure provides a system and method of creating a searchable company database, the method comprising the steps of: a) having at least one selling company enter company information using a user interface; b) creating a selling company profile database, where the database categorizes the company into a least two tiers of a hierarchical classification system based on the information entered in step a); and c) permitting users to identify a company of interest based on a hierarchical classification system.

The invention where in step c) further permitting identification based on searchable text strings.

The method of the invention further comprising creating keywords based on the information entered in step a).

The method of the invention further comprising in step c) permitting the users to identify a company of interest based on the keywords.

The method of the invention further comprising creating metatags based on the information entered in step a).

The method of the invention further comprising in step c) permitting users to identify a company of interest based on the metatags.

The method of the invention further comprising allowing users to create identifiers based on commonality of commercial interest with at least one of the companies.

The method of the invention further comprising creating links between the user and the company based on the identifiers.

The method of the invention further comprising maintaining a database of internet references to the company and making the reference database available to the company.

The method of the invention further comprising providing tools for validating and modifying Wikipedia listings relating to the company.

The method of the invention where the company is an emerging technology company.

The method of the invention where in step b) the hierarchical classification system includes a technology domain classification.

The method of the invention where the company has multiple technology domains.

The method of the invention where the company can make additions to the hierarchical classification system.

The method of the invention further providing allowing users to select a company for further investigation.

The method of the invention further comprising allowing users to create their own categories for archiving information on select companies.

The method of the invention further comprising allowing users to annotate archived information for either private or team visibility.

A method of managing a searchable company database, the method comprising the steps of: a) having at least one selling company to enter company information using a user interface; b) creating a company profile database based on the selling company information entered in step a); c) permitting at least one investigating company to access the selling company information; d) identify at least one selling company as a target company; e) establishing a group comprising members of the investigating company for investigation and decision making regarding the target company; and f) inducing members of the group to confer with each other via electronic communication.

The method of the invention where the electronic communication is selected from the group consisting of discussion group postings and private email chat.

The method of the invention where the electronic communication includes hyperlinks to target company information.

The method of the invention where the electronic communication includes communication from group members to the group.

These and other features and advantages of this invention are described in, or are apparent from, the following detailed description of various exemplary embodiments of the apparatus and methods according to this invention.

### BRIEF DESCRIPTION OF THE DRAWINGS

FIG. 1 describes the software architecture and physical architecture of the invention, and illustrates how various user types access the user features.

FIG. 2 illustrates the user entering a keyword search string which returns multiple pages of abbreviated emerging tech company profiles, each of which can be expanded to reveal a detailed company profile.

FIG. 3 describes the method of prioritizing and weighting the various categories of company profile text so that keyword and metatag search returns are presented in order of highest relevance.

FIG. 4 contains an example of the hierachical designation system for emerging tech companies, and illustrates how an individual company can assign itself multiple designations, as well as defining its designation using new values which it suggests.

FIG. 5 illustrates how a customer or other user would browse for companies using the heirachical system of designations.

FIGS. 6a -6d is an outline of the database schema for the detailed profile of an emerging technology company

FIG. 7 illustrates how customers can discover which emerging tech companies are targeting the customer by market segment, business unit, and functional area.

FIGS. 8a and 8b describe the method of matchmaking used when both buyer and seller wish to identify the highest level of mutual attraction: most-willing buyer and most-willing seller.

FIG. 9 is the menu screen that leads a user to the steps that will create and manage teams and team decision processes

FIG. 10 illustrates a sample use case where the user has created a unique team to find emerging technologies for each of three customer-company initiatives.

FIG. 11 illustrates the user process for creating a new team

FIG. 12 illustrates that a single user or a team can create multiple short lists in order to maintain separate workspaces and discussion for separate initiatives or search assignments.

FIGS. 13a and 13b describes how an individual can capture his or her learnings from multiple browsings or search arguments by building a personal short list of companies, together with his or her private notes annotated to the company profiles

FIG. 14 illustrates a sample case where three users on the same team are working separately and concurrently to discover, evaluate, and prioritize emerging technologies that they believe will be serve either their departmental best interest, or the corporate best interest, or both.

FIG. 15 shows how the sum of individual short lists is displayed on the team short list, and how this matrix, reveals which technology companies have gathered support from a plurality of users, and encourages team members to comment on whether and how a specific emerging technology company should be investigated further.

FIG. 16 contains the calculations used to determine ranking within a team short list

FIG. 17 describes the core process of the invention.

FIG. 18 describes an online service that enables buyers to approach sellers with a rapidly structured email that helps both buyer and seller enter into an immediate and efficient dialogue, and quickly ascertain the probability of doing business together.

FIGS. 19a and 19b describe the user registration process. The two figures are a single flowchart; 19a is the left side and 19b is the right side.

FIG. 20 is an embodiment of a hardware configuration for use with the invention.

### DETAILED DESCRIPTION OF THE INVENTION

The detailed description of exemplary embodiments describes the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Embodiments of the present invention employ software components that operate with network devices and related hardware to manage the movement of electronic information, store the information format and provide controlled, world-wide access over the Internet to the information. The information may relate to text and other media (e.g., audio, visual, and/or audio visual files) that are provided in an electronic network context, and the system and services may involve users of an electronic network.

For example, embodiments of the invention relate to systems and processes for managing data regarding a variety of interests of a plurality of users over a wide area network, such as the Internet. Embodiments of the system and methods disclosed are particularly suited for collecting and managing data relating to one or more users (and/or one or more groups of users), where the managed data may be used to provide access to the data, via the network, to other users via the network.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of age-appropriate goods, services or information over any network having similar functionality described herein.

In general, the present invention describes a decision-making system to efficiently and effectively discover, investigate and implement emerging technology by mid-size and large businesses. This decisions-making system is not limited to analyzing emerging technology and can be used to in other areas of information mining where complex information is compiled, organized, accessed, and presented using the processes described in this invention.

In this description, the term “emerging technology” refers to products, systems, methods and/or services that are in the later stages of the development cycle, from early prototypes and demonstrations through to commercially available equipment, products, services, systems and/or methods. Emerging technology products that are “market-ready” are typically in the early stage of establishing a market position.

An “emerging technology company” is one that was established to transform intellectual property into a marketable product and bring the product to market. The “company” entity can be a start-up company that is funded either by private funds or venture capital. Or the “company” can be a business unit or subsidiary of a much larger entity, as when a new product is incubated in isolation from the day-to-day business of the parent company. The focus for most users of the present invention will be on products that are ready-for-market. However, a significant number of users of the invention will want to search for pre-release and pre-product companies. Products can range from materials to ingredients to finished goods to fully shrink-wrapped consumer products. However, in most cases the go-to-market plan is business-to-business.

“Emerging technology catalog or register” means a compilation of emerging technology companies and a list of products, services, systems and/or methods profiles together with value proposition statements and company background. In addition to posting their company and product profiles within the invention's catalog, emerging technology companies will use the invention as subscribers in order to discover competitors, related technologies, symbiotic technologies, and potential alliance partners.

“User” refers to any human who is registered or unregistered and is using the system (whether currently logged on or not). “User” is distinguished from “Company”. A single company can have multiple users.

“User type” refers to the kind of company the user works for or is agent of. User types can be: emerging tech company, enterprise buyer, venture capital or investor, media, advertiser, or “other”. All user types have access to all user features of the invention, with the exception of defining an emerging technology company profile. That function is restricted only to users who are registered with their user type as “emerging tech company”

“Findability” means the ability to be found by the target market. Target market personnel (buyers) typically use their own familiar industry terms as search arguments to look for products and solutions. Emerging tech companies, whose core staff often have just emerged from the academy, typically describe their product in scientific, academic, or visionary terms that are foreign to their buyers. And therefore, they are not findable. Findability also applies to the contra-indicated market or contra-indicated application. As an example, there were no words or phrases or categorization within Bayer AG's marketing information from 40 years ago that would have matched a search engine argument for “blood thinner” or “heart disease”, and therefore, Bayer Aspirin was not findable for this purpose.

The term “link” or “links” refers to establishing one or more association between various data items on file within the invention or based on metadata or based on the actions or inputs of a user. An example is the selection by a user of an emerging tech company to include in his short list. In this case the existing company abbreviated and detailed profiles are “linked” to the user. The company is also linked to the team short list, as is the user's name, as is the user's personal ranking of this company, as are team discussions regarding this company, as are personal private notes entered by the user. These examples are not all-inclusive. The links are relational, not linear. The invention is able to establish and re-establish the links from multiple points of entry by multiple individual users provided they have the proper permissions.

This definition of“link” or “links” may also refer to hyperlinks which can interact with the Internet or a local intranet or similar networked computer system.

References to “Metadata” “Meta Tag” and “Tag” within this specification refer primarily to data and searches within the invention itself. As used in this disclosure, these words do not necessarily refer to the practice of placing metadata within a company's website to make that company more findable by search engines, although that is in fact a common definition of “metadata”.

The term “metadata” refers to the data mining activity where a wide range of broad characteristics and specific identifiers are used to identify a range of individuals, or companies, or trends. In performing metadata actions the invention can rely on data on-board within its company and user profiles and user-action archives, as well as associating this metadata with external sources.

“Meta-tag” is used, as an example, to assign values entered by users to refer to pick list definitions or self-definitions of their own market segment or technology domain; and their pick list and self-definitions of target market or target technology domain. In the case of this example, the term “keyword” does not suffice. These examples are not all-inclusive.

“Meta-tag” or “Tag” can also refer to a term of convenience that a user might wish to suggest while in the course of studying, as an example, a specific emerging tech company profile. The user might say, for instance, “If only someone had ‘tagged’ this company with value X I would have found it with my first search argument. I will now do everyone a service and actually enter this value as a tag. That way, the next person to use value X for search argument will more likely find this company.”

“My short list” is a filing mechanism that enables the user to preserve information from each of his many search arguments, without having to keep penciled notes off to the side, or build a cut-and-paste compendium, or maintain website bookmarks.

“Domain-Industry-Sector-Subsector” is the hierarchal lexicon of worldwide technologies.

“Decision tool” and/or “decision software” enables staff and management to view, study, and prioritize the catalog research of their work team. Decision tools are labeled for the users as “Team Short List” and “Team Forums”.

“Short list” and/or “my short list” means an individual user's private index of technologies of interest that the user has marked while searching the entire database. The user can name and save multiple short list files on impulse, repetitively.

“Group selections” and/or “team short list” means the compiled and ranked short list for a customer working group. If the individual user short lists are considered to be “votes”, then Group Selections represent the election results. The Group Selection ranking of emerging technologies of mutual interest to the entire working group can be used by management in their raw form. Or, at his option, the executive subscriber can apply varied weightings to the votes of the individual users. The executive subscriber can also choose to override the “election” results and designate his own final ranking of the group selections.

“Strategic” means adopting emerging tech early and effectively, with minimal expenditure of resources, so that the buyer is able to enhance his own customer-value proposition and differentiate from his competitors. “Strategic” also implies that the buyer has adopted prior to most of his competitors.

“Customer”, “customer company” or “buyer” generally refers to an enterprise that purchases and implements products from an emerging tech company. “Buyer” can also refer to an individual employee or agent of that customer company. A customer company can also be another emerging tech company. (The roles of buyer and seller are not mutually exclusive) Finally, for purposes of describing the invention's processes, “customer” and “buyer” can refer to a user who wishes to study the marketplace, without ever having the intention of buying product.

“Selling company” means the emerging tech company that is offering product to the buyer, and has a company profile posted.

“Detailed company profile” refers to the complete display of data presented by the invention to the buyer. The detailed company profile is seen by selecting a hyperlinked company names as they appear in search returns and short lists. The detailed company profile includes data on the selling company's products, company background, executive biographies, hierarchical domain definitions, target markets, etc.

“Selling company private profile” refers to keywords and metatags, contact information, and other data required for day to day management by the invention's administrators. Some of this “hidden” data is also used to execute advanced buyer searches.

“Pick list” refers to a stored set of values for the user to select from when completing their personal or company profile. Use of pick lists assures that the syntax used for search description is exactly the same as the syntax used for profile definition. Within this specification we primarily refer to pick lists that define technology domains and pick lists that describe market sectors.

“System administrator” refers to persons supervising operation of the invention on a day to day basis. There are several levels of system administrator permissions, but for purposes of this disclosure, they are all referred to as “system administrator”.

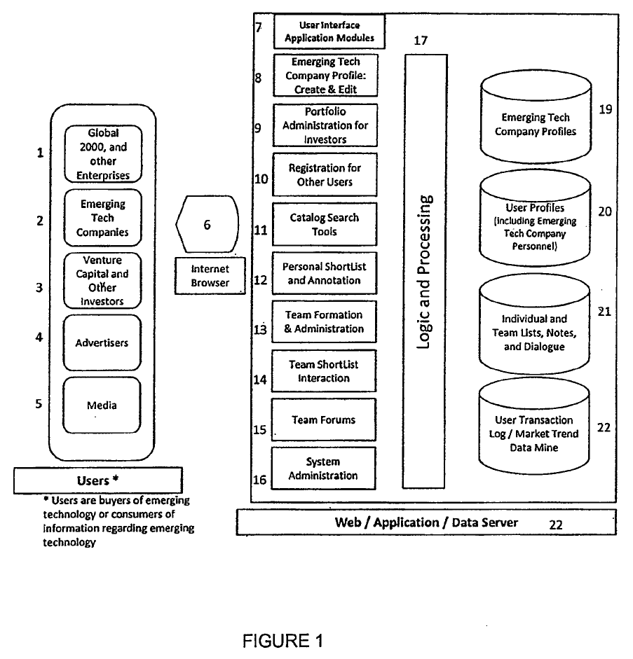

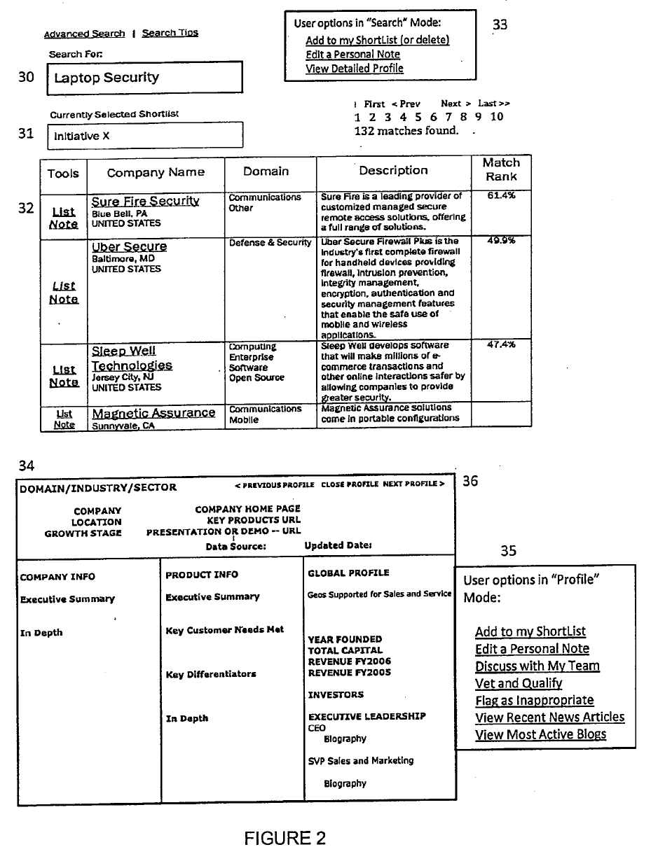

Referring to the figures, the block system diagrams and process flow diagrams represent mere embodiments of the invention and are not intended to limit the scope of the invention as described herein. For example, the steps recited in FIGS. 1, 8a, 8b, 17, 18, 19a and 19b, may be executed in any order and are not limited to the order presented. Furthermore, the user interface elements of FIGS. 2, 3, 4, 4b, 5, 6a -6d, 7, 8b, 9, 10, 11, 12, 13a, 13b, 14, 15, and 16, may be presented in any arrangement and may include more or less elements than is shown.

User Processes:

FIG. 1 shows the application and system architecture of the invention and illustrates that the users 1-5 access the system by means of a standard web browser. Users interact with various user interface application modules 7-16 as appropriate to their user type and current actions. There are a variety of databases 19-22 architected to optimize specialized tasks. The invention functions within the conventional architecture of web server and application and computer-based data server.

Nine user interface modules are depicted in FIG. 1. Several of these modules are reserved for specific purposes. “System Administration” 16 may be reserved for use only by the operators of the invention. “Emerging Tech Company Profile” 7 and “Create and Edit” 8 may be reserved for use only by selling company users. “Portfolio Administration for Investors” 9 may be reserved for use only by venture capitalists and other investors who wish to monitor and comment directly to members of their investment portfolios on how the companies might improve their profiles. Five of the nine user interface modules are for use by any user type.

The invention does not limit its users to a simple binary world of buyer and seller. Instead it accommodates the need to treat selling companies and investors uniquely, allowing them to use the system as if they were buyers. For example, an emerging tech company may be looking for an alliance partner to either fill a hole in their product line, or looking to see if there are alliance possibilities for co-marketing to customers, such as when the two emerging tech products working in tandem deliver better customer benefits than either product working alone. In this case, the emerging tech company, in searching for an alliance partner, would want to utilize the same search, study, and team decision tools used by the customer, even though in this case the emerging tech company is not going to literally be a “buying” customer.

FIG. 2 depicts an example of the search results returned to a user that has entered a search argument “Laptop Security” 30. In this example “laptop security” could be significant as either a keyword or metatag for search purposes. The system returns one or more pages of summary descriptions for emerging tech companies 32.

This is a distinct improvement over the customary method used to search for emerging tech companies, which is to use Google or other search engines. If“laptop security” is entered into Google as an argument, the search results will contain many pages of references to publications or other media appearances. Publications are not emerging tech companies and the publications and articles may or may not contain content that leads the user towards discovery of relevant companies. The user might have to evaluate content large amounts of content to find even the first ten companies. The present invention returns relevant information on the first search attempt.

While Google search returns often contain the home pages of companies relevant to the search argument, the companies that are listed in the early sequence of Google search returns are those that have the highest comparative volumes of traffic to their own web sites, or send and receive the highest volume of linked traffic between their sites and other sites, or have otherwise taken significant and costly steps to optimize their presentation position on each of the top ten web browsers. These characteristics describe the polar opposite of the typical emerging tech company, and therefore these companies' web sites, if they show up at all, will show up only after many pages of Google returns. Often the user will abandon the evaluation of the multiple search return pages before finding what might in fact be the most relevant and desirable emerging tech company. These concepts are supported further in the discussion of Experiment 1.

FIG. 2 also contains the outline and layout of a Detailed Company Profile 34. Users can view the detailed profile by selecting a company's hyperlinked name within the search returns 31. Once the detailed profile is visible for a single company, the user can “scroll” through all the companies contained in the returns delivered for his search or browsing argument. There are also “previous profile” or “next profile” commands 36 to assist the user in easily scrolling through the search information. The user can easily return to the pages of summary search returns by selecting the “close profile” command 36.

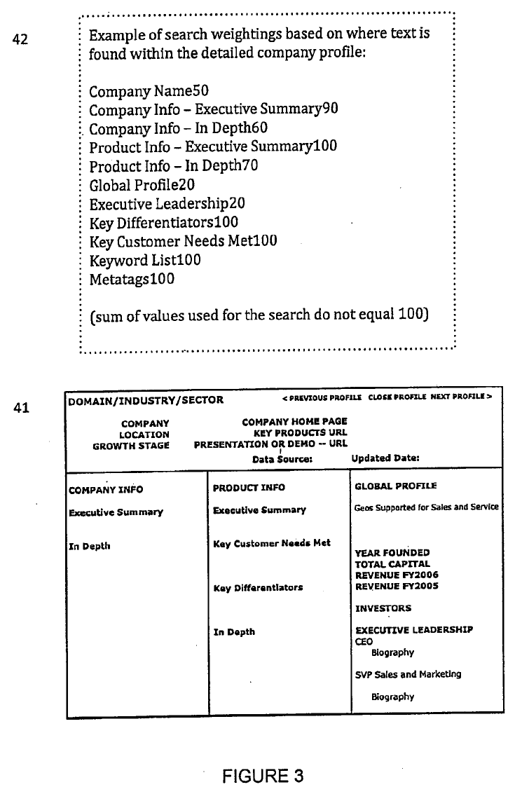

FIG. 3 shows how various categories of text within the detailed profile are weighted 42, 41 prior to the calculation that places the search returns in sequence for presentation to the user. The system administrator can alter the weightings in order to optimize performance and relevance based on actual use with actual profiles (FIG. 2, 34). An example of the value of these weightings is the insignificance (for search purposes) of the biographies of a company's senior officers. Suppose that the CEO of a sludge-digesting-bacteria company is a former VP of sales at a laptop security company. This weighting step would not place the sludge-digesting company high in the sequence of returns for the “laptop security” search argument.

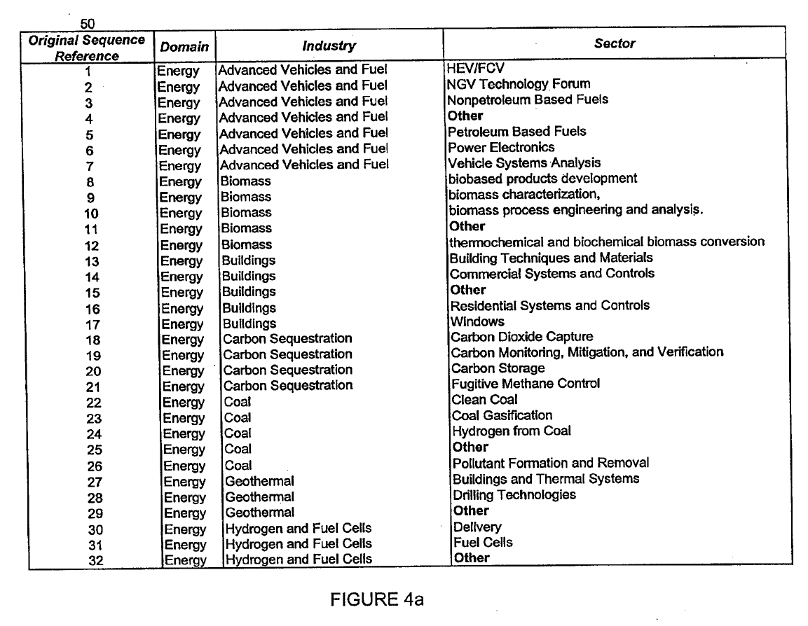

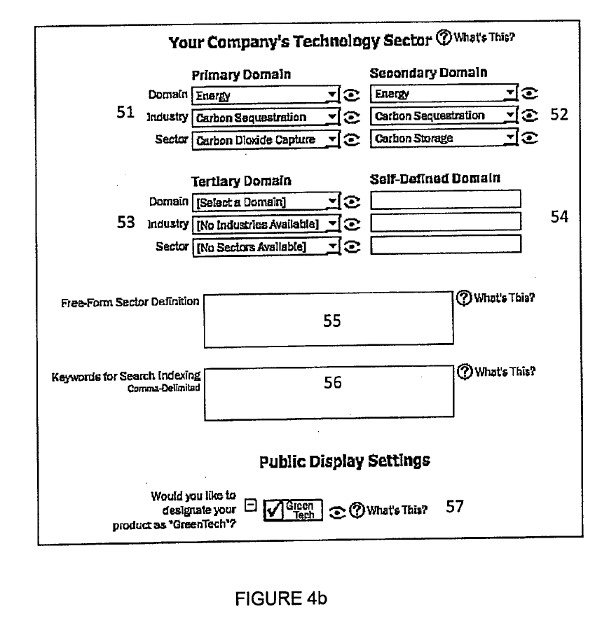

FIGS. 4a and 4b display a small sample of the invention's hierarchical designations for emerging technology domains, industries, and sectors 51-54. FIG. 4a discloses an “emerging tech pick list” 50. Subsectors are also used when helpful, but subsectors are not needed within this sample of the energy domain. “Hierarchical” means that the list of industry values available for selection is dependent on the prior selection of domain; and the list of sector values available for selection is dependent on the prior selection of industry.

FIG. 4b shows how an emerging tech company uses the emerging tech pick list 50 to enter its domain designations as part of building its company profile 51. The invention allows the selling company to describe itself at least three different ways 51-53. If the hierarchical system is felt to be inadequate, the selling company can enter a narrative description of its technology sector 55. Soliciting free form input from selling companies assists in keeping the domain pick-list values current. As different categories of emerging tech are created in the marketplace, the most authoritative and complete definitions of what these new things are will come from the selling companies that are working to bring them to market.

FIG. 4b also shows the area where selling companies can enter a list of keywords to make themselves more findable 56. The presence of keywords in a company profile, and the weighting step the invention applies to the keywords (FIG. 3, 42) reduces the creative load on the selling company and enables a faster and easier creation of the company profile. In contrast, in order to be found and listed early in the sequence of a Google search results list, the selling company needs to first identify the keywords most likely to be used as search arguments by buyers. Then the selling company must construct all of its searchable text to optimize the frequency of these keywords. It is an overwhelming, burdensome and time-consuming task to enter these words throughout text while at the same time telling a coherent story and engaging the human reader. The disclosed invention substantially reduces the necessary time investment, allows the selling company to be liberal in its selection of keywords, and presents a more relevant search result for the user.

FIG. 4b further illustrates how the selling company can choose to identify itself by a global designation. In the case shown 57 the selling company can choose to designate itself as Green Tech. The searching user can then use “Green Tech” as a filter to refine his search results. Provision is made within the system to add additional global designations as needed.

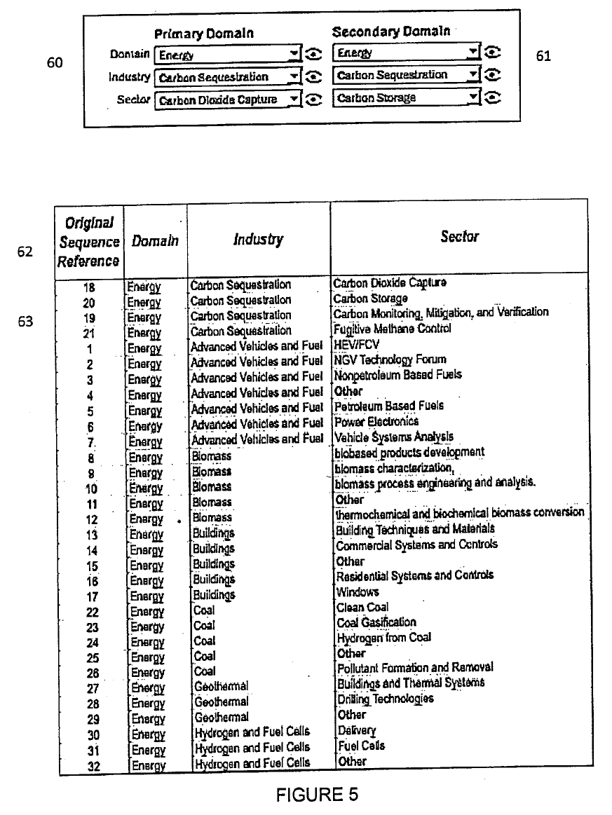

FIG. 5 illustrates how the buyer enters values to browse the invention's catalog by sector. In the example provided 60-61, the buyer has asked to see both carbon capture and carbon storage companies. The system will deliver search returns in the appropriate order 62 based on the values those companies have selected in their domain designations. The system will return results based on the values present for domain, industry and sector. In this example, all the carbon sequestration companies (industry) are presented to the user even if there are no companies that match the “carbon storage” (sector). This allows the buyer to browse the carbon sequestration companies at a minimum. The system also returns, next in order, the entire range of companies in the energy domain 63. The match rank percentage for these following companies will likely be substantially lower than for the companies that had matches on the buyer's domain search argument. This enables the buyer to efficiency scan through detailed company profiles to obtain a personal primer on what exists within the entire energy domain.

The system also provides an advanced search feature that enables the buyer to refine search returns in a single step. Using this feature, the user could ask a composite search argument as follows: “show me the companies in domain=energy and industry=coal, that contain a match for keywords=X, Y, Z, and filter=green tech.”

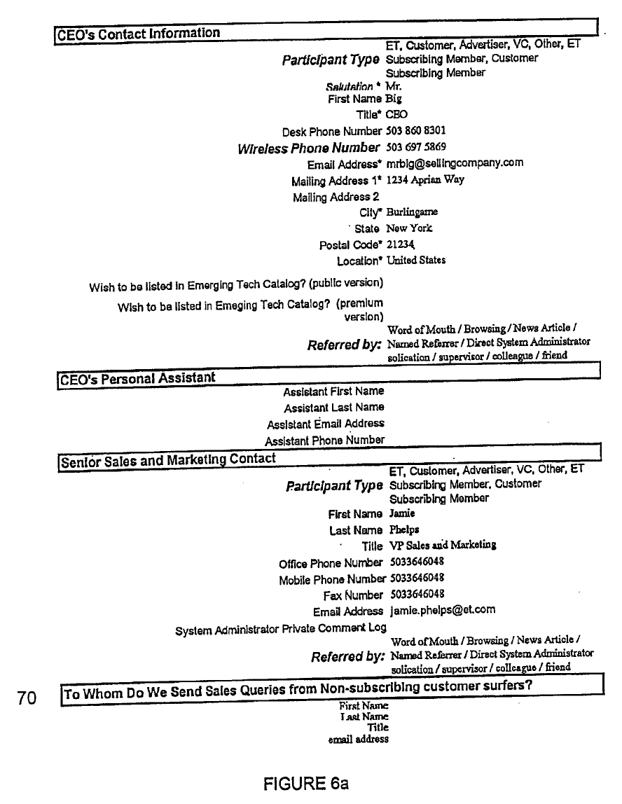

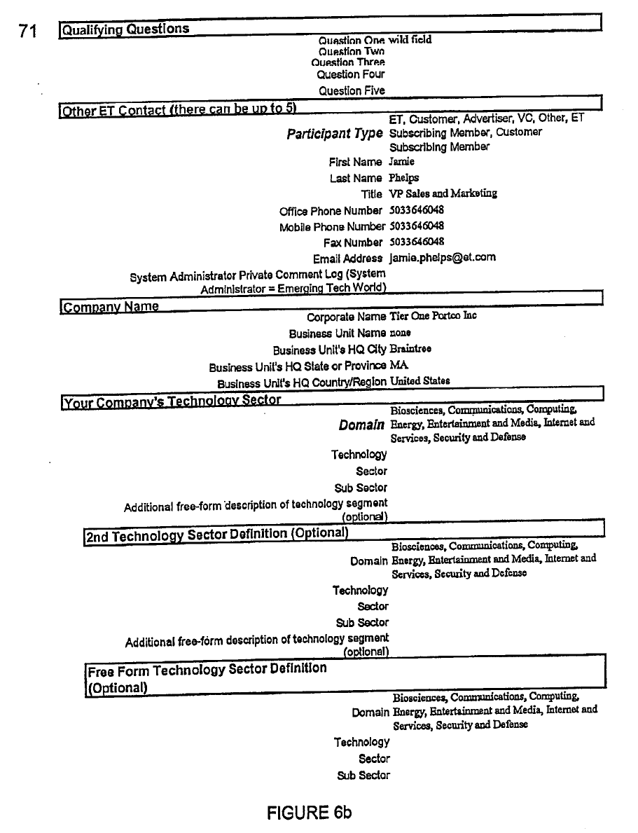

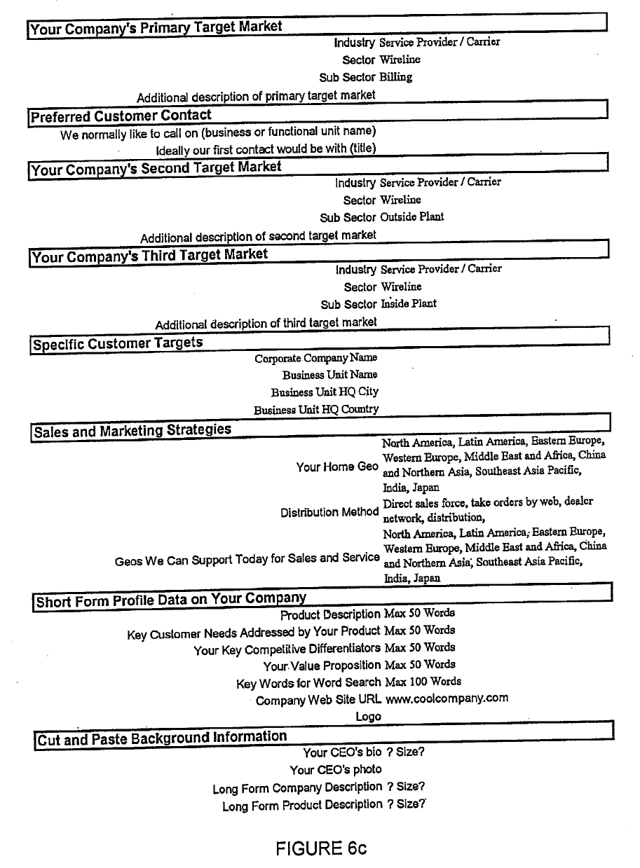

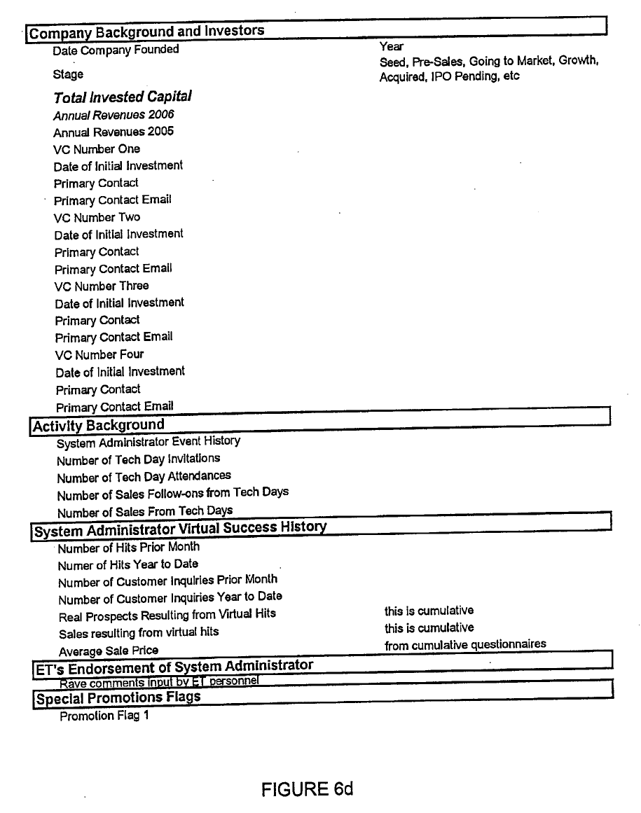

FIGS. 6a -6d illustrates the current database schema for a selling company profile. Some data fields may be visible to buyers and some may not.

During profile creation and update, the invention will search a web-based database such as Wikipedia and/or other web resources in order to confront the company with how its technology is being characterized, if at all, in the publicly available media. Tools and instructions for updating or challenging Wikipedia information and other web listings are provided by the invention. The company is also asked to consider whether metatags present in the Wikipedia listing should not also be included in the company profile.

A historical example of the merits of this method involves the emergence of WiFi and 802.11. The year 2003 was the tipping point for adoption of wireless internet connections from laptops within WiFi hotspots. Approximately 40 different new technologies had to be brought to market in order for the laptop user's wireless experience to be realized. In 2003 customers would search for these technologies using the keywords, “WiFi” and “802.11” the terms that were being used then by the high tech trade press and industry standards groups. However, several years earlier, when the 40 companies first constructed their sales and marketing collaterals, these popular terms did not exist. Instead, the descriptions referred to “low-power data transmission at 2.4 gigahertz.” In 2003, at precisely the moment the market demand hit the tipping point, only a miniscule portion of the Global 2000 market had the body of knowledge necessary to construct the search strings that were required to find these 40 companies as they were then self-described. It was imperative, therefore, for these companies to incorporate the new industry standard terms into their descriptive texts.

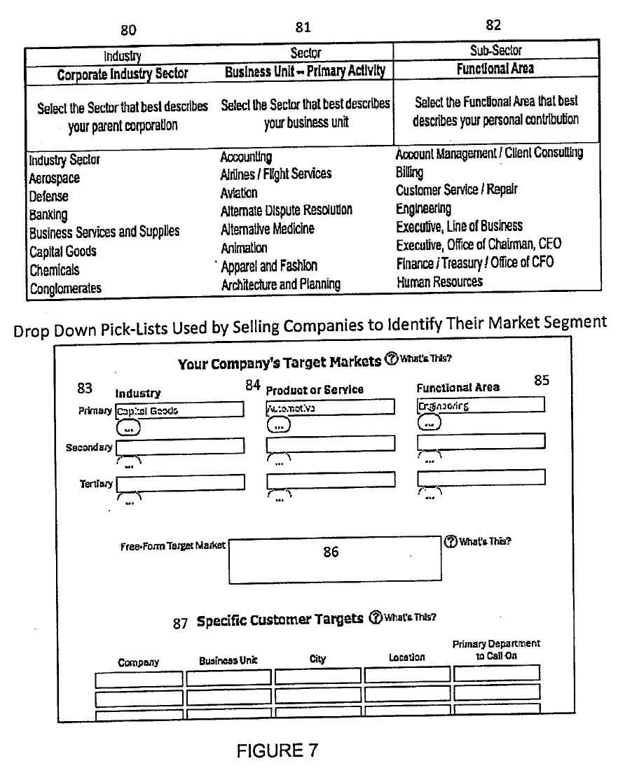

It is contemplated in this invention that, prior to beginning their searches, buyers will register a personal profile on the system (individual human users within a selling company are also treated as “buyers”). FIG. 7 shows the pick lists used to designate the buyer's company market sector as well as the buyer's business unit and personal area of responsibility 80-82. These pick lists are not hierarchical. All the values that exist in each of the three categories are available for selection by the buyer.

FIG. 7 further illustrates how the selling company can use the same pick list values to identify target markets (e.g., Industry, Product or Service, Functional Area) 83-85. The system enables the selling company or user to designate three target markets. The system further enables the selling company or user to designate a list of its specific highest value targets 87. This is useful because it is typically very difficult for an early stage company to gain access to the right decision makers at very large enterprise customers. This further assists in keeping the contact information for any one company or user current.

The values entered by seller and buyer in FIG. 7 enable the buyer to answer the question, “Who wants to sell to me?”. In the present day, the prudent buyer feels in control when searching for an innovative solution for a problem he already recognizes and is determined to correct. This same prudent buyer has a corresponding dread when contemplating that which he does not know, and a concern that his competitor might find a game changing technology before he does.

The present invention allows the buyer to filter his searches by his own registered market segment, or any market segment of choice, on an ad hoc basis 83-85. This enables the buyer to study technologies that he may not have been aware of, and then ask himself the questions: “Why does this company think I'm a target?” “What solution do they have for a problem I am not even aware of?” “What is at risk if my competitor implements this before I do?”

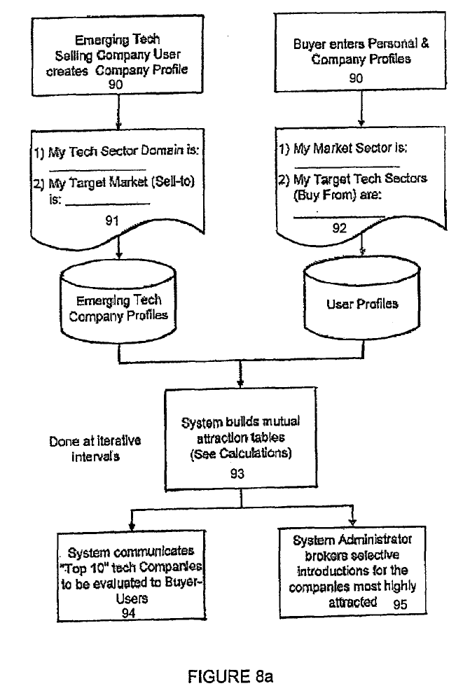

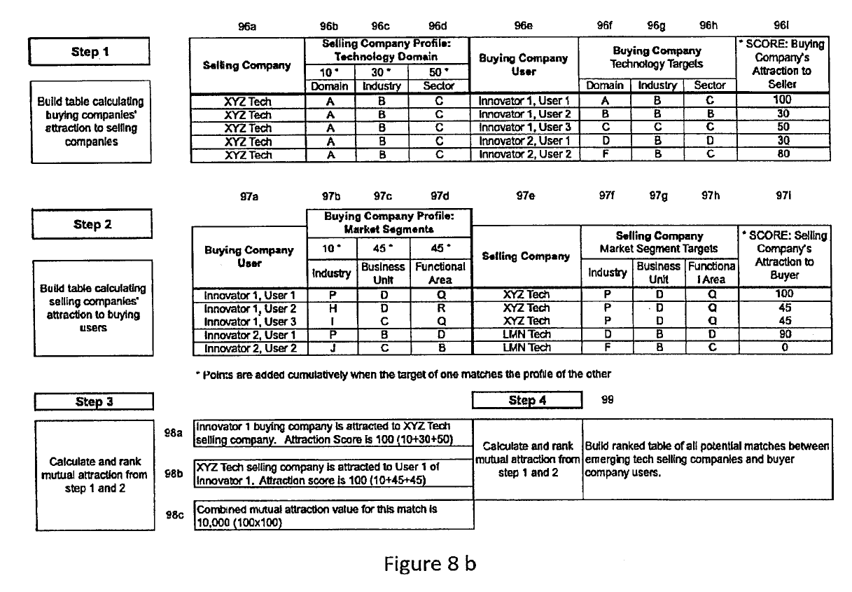

FIGS. 8a and 8b describe how the selections by both seller 90 and buyer 90 of the values for technology domain 90, 92 and market segment 90, 92 can be used to produce a binary listing of companies most strongly attracted to each other 93. The result may be a listing of companies that should consider meeting each other because the buyer has exactly (or close to) the profile the seller wants to approach, and the seller has exactly (or close to) the profile the buyer wants to evaluate 95. In the event of strong matches, the invention proactively notifies the buyer and provides a list of sellers ranked for the highest level of mutual attraction between buyer and seller 94. The buyer can then view company profiles, study, and decide whether to initiate contact with the seller(s).

FIG. 8a is a flowchart describing Matchmaking. Matchmaking is an additional and optional feature of the invention. Matchmaking is a method for introductions between buyers and sellers who have the highest degree of mutual attraction for each other. Matchmaking as defined here is a binary operation. Although, as noted previously, the invention does not limit user types to binary opposition since the invention allows emerging tech users to act in the roles of buyer, as well, as seller.

Matchmaking calculations are performed on regular intervals by the system, independent of any user action 93. In one embodiment of the invention, the tables of mutual attraction are prepared in advance making answers, such as “who's attracted to me?,” immediately available to the user. The preparation of attraction tables in time intervals also enables the system administrator to view and observe exceptional levels of mutual attraction that might merit a proactive introduction by the administrator 95.

In order to perform the calculations, the invention utilizes collected user profile data from both selling companies 90 and buying company users 90. This is done as a matter of course in user registration and selling company registration (FIGS. 1, 4, 5, 7, 8a, 8b, and 9). The selling company user 90 describes its technology domain 91 and its target customer market segments 91. The buying customer user 90 uses congruent pick list values to describe his own market segment 92, and congruent pick list values to describe his target emerging tech domains 92 for evaluation.

Once the calculations 93 have been completed, interaction with the actual users 90 can begin. At the option of the system administrator, the invention can create email notifications 94 advising individual buying customer users of the Top 10 selling companies for which there exists the highest level of mutual attraction between them personally and the selling companies (within the universe of users). The buyer then logs on to the invention to view company profiles, study, and decide whether to initiate contact with the seller(s). The system administrator can also elect to perform a higher touch method of personal introductions 95 in the case of exceptional levels of attraction, especially those were the game changing potential for the buyer's business operation is exceptional.

FIG. 8b describes the calculation process used to prepare the ranking of most-attracted selling companies and buying users. Step 1 is determining a score for the attraction of the buying company to the selling company. This is done by measuring the degree of matches between buyer's technology (buy-from) targets and seller's technology profile.

As an example, buyer (Innovator Company 1, User 1) 96e,f,g,h describes the primary-target emerging-technology as Domain=A, Industry=B, and Sector=C. The selling company (XYZ Tech) 96a,b,c,d describes its technology domain primary-profile as Domain=A, Industry=B, and Sector=C. To calculate the degree of buyer's attraction to seller, in this case, 10 points are awarded for the domain match (matching value=A) 96b 96f. For them industry match (matching value=B) 96c 96g, 30 points are awarded. For the sector match (matching value=C) 96d 96h, 50 points are awarded. Adding these values together delivers the attraction score of 100 96i. Significant variation in the results is obtained through the described attraction scoring method 96i allowing users to quickly analyze the compiled information.

FIG. 8b also describes calculation Step 2. Step 2 generates a score for the attraction of the selling company to the buying company user. (Note, that if there are X number of users within a given buying company, these calculations are performed X times—with a different result for each user.) This is done by measuring the degree of matches between buyer's market segment profile and seller's (sell-to) market segment targets. The buyer (Innovator Company 1, User 1) 97e,f,g,h describes the primary-target emerging-technology as Business Unit=A, Business Unit=B, and Functional Area=C. The selling company (XYZ Tech) 97a,b,c,d describes its technology Business Unit primary-profile as Business Unit=A, Business Unit=B, and Functional Area=C. To calculate the degree of buyer's attraction to seller in this case 10 points are awarded for the Business Unit match (matching value=A) 97b 97f. The Business Unit match (matching value=B) 97c, 97g is awarded 45 points. The Functional Area match (matching value=C) 97d, 97h is awarded 45 points. Adding these values together delivers the attraction score of 100 97i. As in step 1, significant variation in the results is obtained through the described attraction scoring method of step 2 96i allowing users to quickly analyze the compiled information.

FIG. 8b also describes calculation Step 3. Step 3 is the multiplication of the two attraction scores from Step 1 and Step 2. In the final list ranking mutual attraction between buyers and sellers there will be a single line item for each of all possible matches in the universe of selling companies and buying users. The line item for the mutual attraction of XYZ Tech (selling company) and Innovator 1, User 1 (buying user) is calculated by taking the buying company user's attraction to seller score 98a and multiplying it by the selling company's attraction to buying user score 98b. This yields the result 10,000 (100×100) 98c.

FIG. 8b also describes calculation of step 4 99, the ranked listing of all calculations performed in Step 3 98a,b,c.

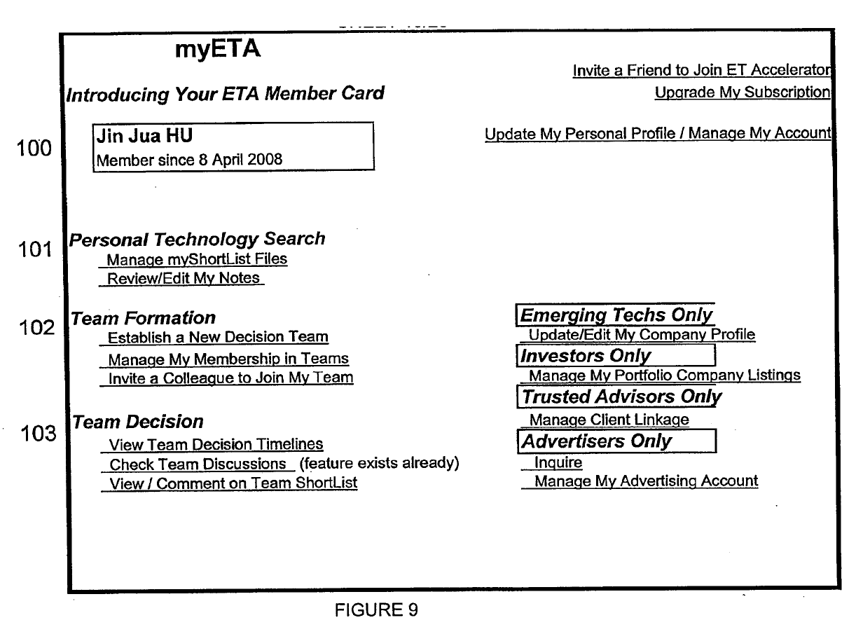

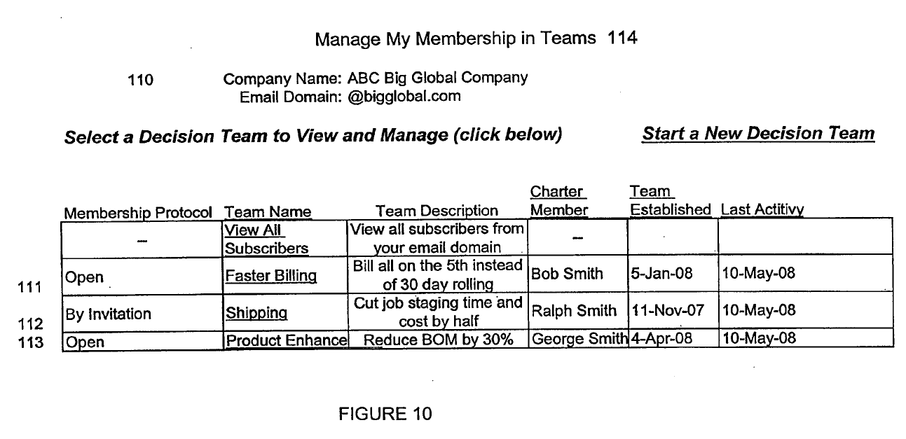

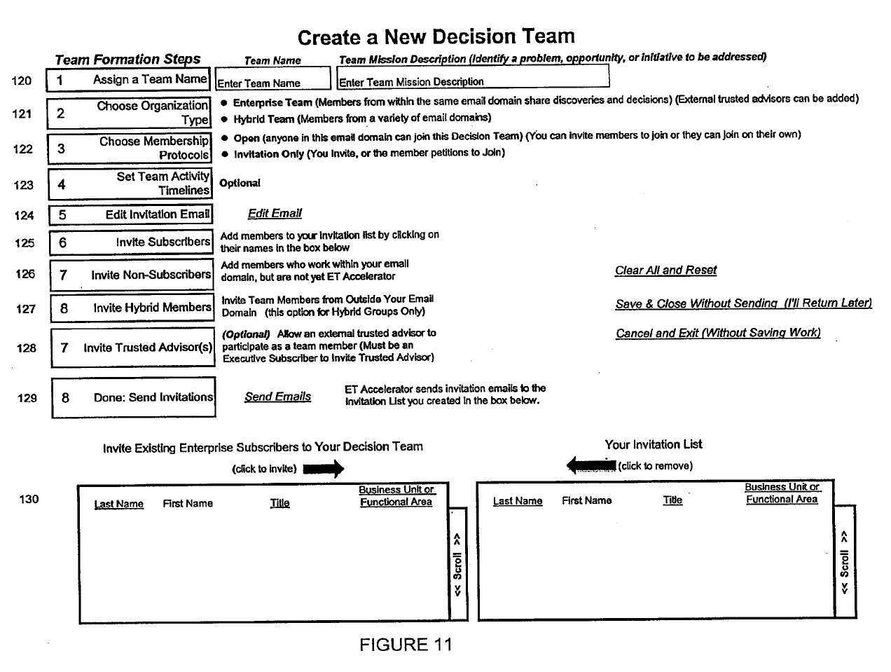

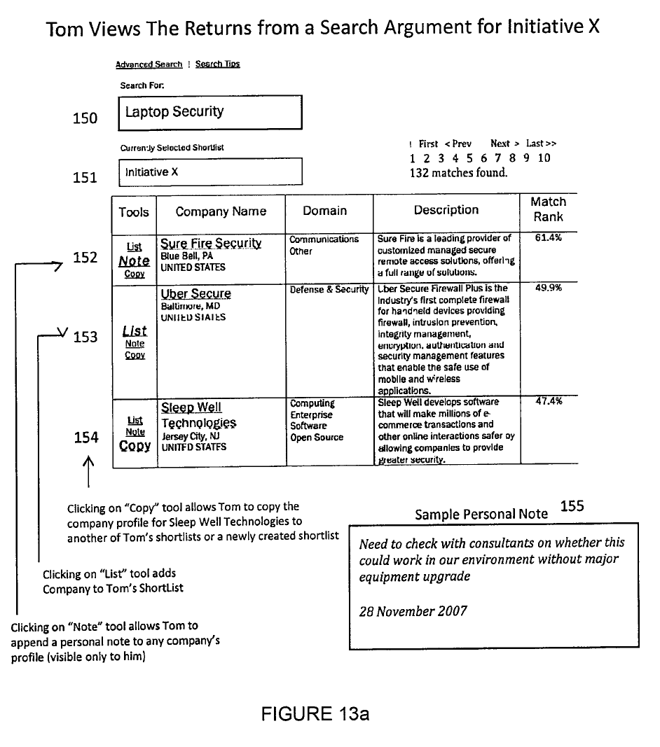

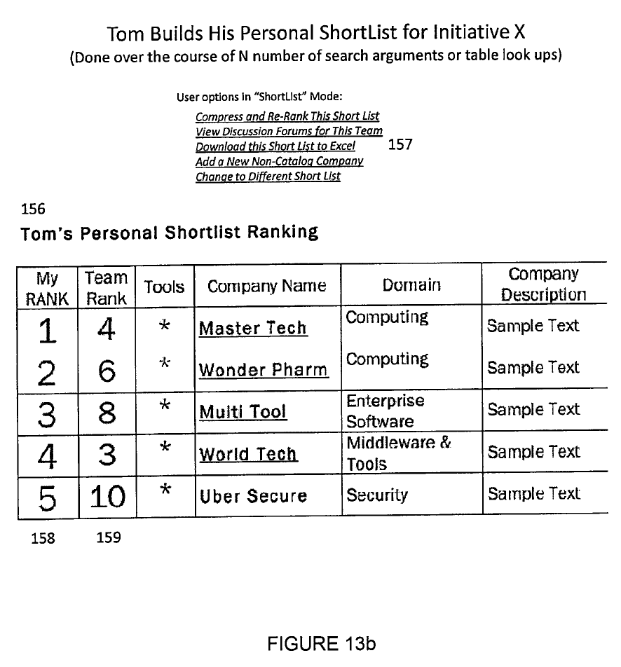

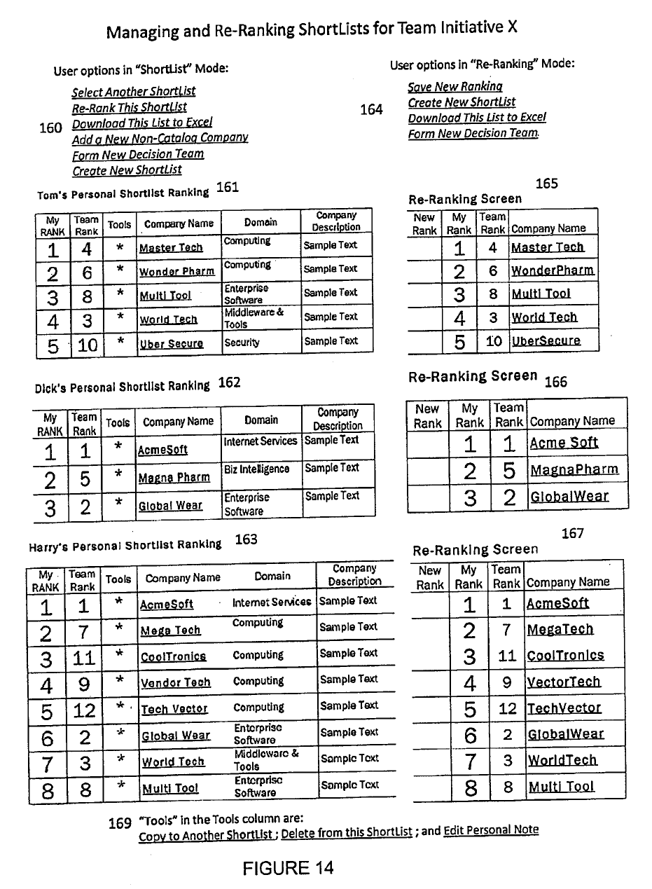

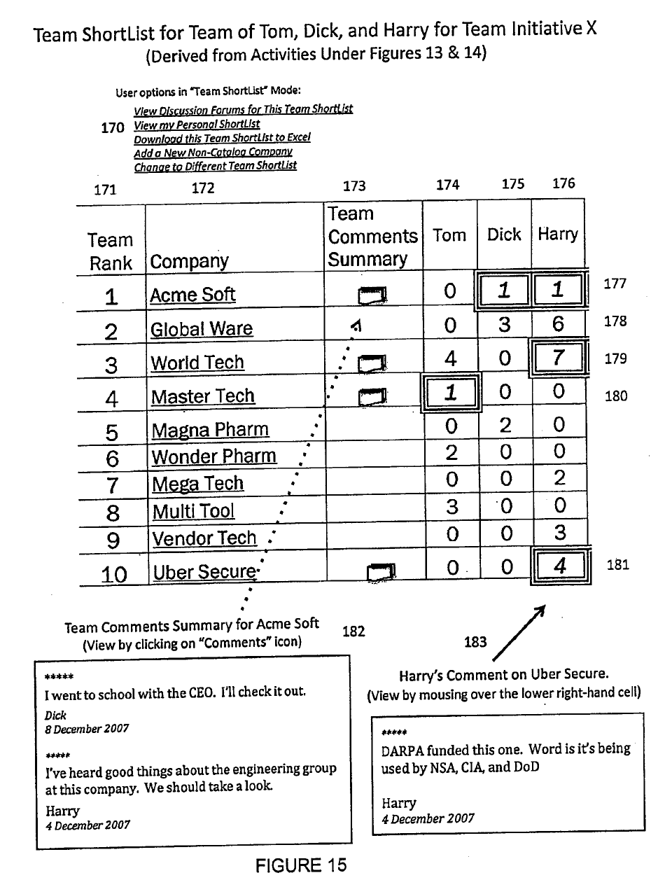

FIG. 9 shows the top level screen used by a buyer for personal administration of his account. The user can add or delete personal short lists 101, and retreive all the personal notes the user has ever appended to any selling company profile 101. (See, FIG. 13.) The buyer can also create new decision teams and manage his participation in existing teams 102. (See, FIGS. 10 and 11.) And, the buyer can access and manage team decision schedules and on-line discussions 103. (See, FIGS. 15-18)

FIG. 10 is another screen that maybe shown to the buyer after selecting any of the team formation links on the screen in FIG. 9. In this illustration, there are different member protocols for the three teams depicted in this users list of current teams 111-113. An “open” team 111 means that anyone who shares an email domain with the buyer, can elect to join or quit the team. A “by invitation” team 112 means that the existence of the team will be revealed to anyone who shares the same email domain, but the user must either be invited or must petition to join the team. A “closed” team 113 means that the existence of the group will be revealed only to users that are members of the group. An invitation by one of the current members is required to join.

FIG. 11 is a single page composite of the steps to form a new decision team. The steps include: assign a team name and define the mission or objectives of this team 120; choose an organization type (enterprise or hybrid) 121; choose a membership protocol (open, by invitation, or closed) 122, and; set team activity timelines 123. Team deadlines can be established at the time of team creation, or added and modified later. The deadlines are for creation of personal short lists, and then a subsequent deadline for user comments to the team short list and team forums, and a final deadline for designation of the teams' “Top 10” selling company selections.

The system may also create ready-made emails and allows for the team sponsor/charter member to insert personal notes 124 and invite subscribers 125. Subscribers may be invited by selecting users from within the team sponsor/charter member's email domain to be members of this team. To do this, the user may select the box containing registered users within the team sponsor's email domain 130 and transferring the selected name to the 131 “invited” box; 126. This function enables the team sponsor/charter member to invite potential users who are within his email domain, but have not yet registered as users of the invention. The sponsor's communications are different because these invitees will have to register as users prior to taking actions as an invited team member.

The invention also has a function to invite hybrid members 127. This option is available only if the organization type selection 121 is “hybrid”. A hybrid team allows members from any email domain—which means explicitly that the findings and proceedings can be openly visible to users from different enterprises.

The invention also has a function to invite trusted advisors 128. This function enables the team sponsor/charter member to invite a trusted advisor who does not have an email address within the team's enterprise email domain. This preserves the “enterprise” characteristics of the team, but enables the external trusted advisor to participate or observe.

The system also creates an individual short list for each team member when “Done: send invitations” 129 is selected. The name of the short list for each individual's use is the same as the name assigned by the team's charter member in the first step of team selection 120.

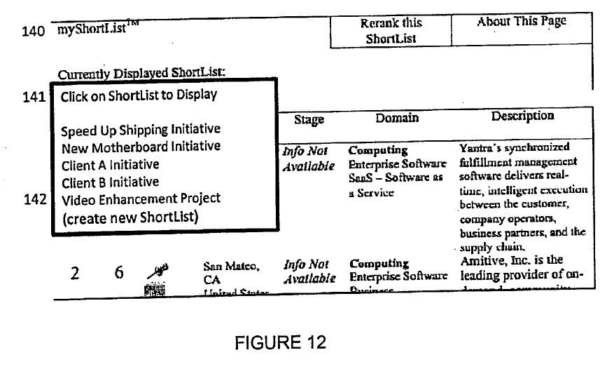

FIG. 12 shows an example of an individual user's selection of short lists to be made active when the user logs on for current search activities. The user will have selected “my short list” from a prior menu. The user is then presented with the current or most recent short list view 140. To change short list views the user clicks on a drop-down box 141, and then selects the next short list to work on 142. The current short list selection 140 also determines which team short list will be presented when the user selects “team short list” for team discussions, provided there is an active team that corresponds to the individual short list. The user may also create personal short lists that have no association with teams.

The significance of this feature is that the invention's design recognizes that a single buying user may be searching for solutions to several problems concurrently, or a procession of new problems over time. The single buying user may want to keep the accumulated information categorized by subject, category or initiatives. The invention allows the user to define archiving terms in an effectively unlimited manner. The user may copy current short list company profiles to another existing short list or to a newly created short list. This eliminates the need to use the search tools to “rediscover” know companies for use in another short list.

FIG. 13a demonstrates how an individual user builds a short list. This activity may be the same whether the user is building a private/personal short list, or whether the user's company selections are visible to members of a team. FIG. 13a depicts an example search return for the argument “laptop security” 150. In this case, the user has already selected “Initiative X” 151 as the destination short list for his current round of study. (See, FIG. 2 [search results]). When looking at the search returns (in either the summary or detailed profile views) the user can mark a selling company profile for further study by clicking on the “List” icon 153. This action delivers the company profile to the user's currently-selected short list, seen on FIG. 13b, 156.

FIG. 13a illustrates that the user can make personal notes and append them to a company profile by selecting the “Note” icon 152 and delivering an editing window where the user can enter a time-stamped note 155. This action can be repeated for the same company profile so that the user's subsequent observations are self-archiving, and the user can track the development of observations and conclusions 155. These notes are permanently appended to the company profile, but are available for viewing only by the individual user that created them.

FIG. 13a further illustrates the user's ability to “copy” 154 a company from one short list to another. This feature acknowledges that companies of interest will sometimes appear on more than one short list, representing their applicability to more than one customer-company initiative. This function of the system allows the user to select and copy one or more companies to another existing short list or to a newly created short list, eliminating the need for the user to re-search and re-discover these companies.

FIG. 13b depicts the personal short list 156 that was generated from the user actions described in FIG. 13a, 153, when the user clicked on the “List” icon associated with a company's search return reference. The short list also contains a personal ranking of the companies the user has selected 158. Each of the user's new company selections arrive in “last” position at the bottom of the user's short list. In this example, the next new selection would display as rank number 6. The user is able to iteratively re-rank the companies on his short list by selecting a single-row compressed view 157. The compressed view (not shown) displays the entire short list in single row form, allowing for a rapid re-ordering of the entire list as required by the user to reprioritize his selections. This compressed view and re-ranking tool is depicted in FIG. 14, 165. The “short list” method depicted in FIGS. 13a and 13b enables the user to preserve information from many search arguments, without having to keep penciled notes off to the side, or build a cut-and-paste compendium, or maintain website bookmarks. To enhance the efficacy of this short list evaluation method, the user is able to create company profiles on impulse 157. This is helpful when a targeted company does not have a profile registered within the catalog. This provides a means for all companies, from all sources, to be visible to individual and team, in the same media and method.

FIG. 13b also demonstrates that the short list method also the user real-time visibility to whether a plurality of interest is forming within his team for any of the individual user's short list selections, by comparing his rank values 158 to the team's rank values 159. Note that the mere addition of a company to a short list does not at that moment necessarily constitute a “vote” for that company by the user, but simply denotes that the user has identified the company for further individual study. Similarly, the team rank 159 is a volatile measurement while other team members are re-ranking their own short lists. The team rank values will remain volatile up until the team's agreed-upon deadline for freezing selected short lists.

FIG. 14 illustrates a side-by-side comparison of a particular team members' short lists 161-163. In this case, the team of Tom, Dick, and Harry are in the process of building personal short lists. The sum of the personal short lists are concurrently rolled up into a team short list (FIG. 15). The individual users can monitor, on their personal short lists, how a consensus is forming in the team. In this example the users can see a consensus forming for: AcmeSoft 162, 163; Globalware 162 163; and World Tech 161, 163. Each user can observe how their individual selections compare to the current group rank (FIG. 13b, 157). Each user also has the ability to instantaneously re-rank a short list by selecting the “Re-rank” link 160. This delivers a compressed view that makes the entire short list visible and re-rankable on a single screen 165-167.

FIG. 14 also illustrates the user's ability to download a short list to Excel or similar program 160 by exporting the company profiles from a personal short list, including personal comments about the companies. This enables the user to apply and leverage the full value of the finished work product for use in other environments.

FIG. 14 also illustrates the user's ability to add a new non-catalog company profile to the database 160. The user may access an input template that allows the user to create a complete company profile for a company that is not contained within the invention's catalog, but which the user would like to consider individually or in a team. This capability further focuses the users' efforts by eliminating the need to maintain and track separate parallel company data within separate and parallel media. New non-catalog company profiles are treated exactly the same as catalog-company profiles for purposes of the user that added the non-catalog company and any associated teams with this user. Non-catalog company profiles may not be visible to users outside of these teams. In this case, the system administrator is presented with a worklist of these new non-catalog companies, and is prompted to determine whether the company should be invited to post a permanent selling company profile.

FIG. 15 shows a team short list. A team short list represents the culmination of all effort expended by team members. It reveals to all team members the team rank for companies under consideration. It allows the user to select company names 172 in order to open detailed company profiles and study companies selected by others that the user had not yet seen. It allows each user to enter personal comments for the benefit of the group. In this example, Harry 176 has selected the cell 181 and entered a comment 183 for the group regarding the company Uber Secure 172 ranked tenth by the team 171. A team short list allows the user to view the sum of all team short list comments made with respect to a single company 173, 182. The user interface allows the user to view additional information by scrolling. Any of the users can export the team short list and team comments to Excel or similar program 170. And any of the users can add a self-created company profile for a non-catalog company 170. The invention further contemplates additional provisions for users to insert a red flag into a cell to alert the team mate to an issue of serious concern that would be entered by the that user into the comments for that company.

The system also allows users to send email communications to prompt team members to go on-line to study and comment on the team short list. A series of mails like this will be sent out beginning with the dates defined for this team (See, FIG. 11, 123). The system monitors a team and may send reminder emails to team members who have not yet commented on the team short list. This email alert function may also provide a deadline for response for any or all of the users or team members (See, FIG. 11, 123). The system may also send email alerts to team members or other users to the presence of new postings to the team forum pages.

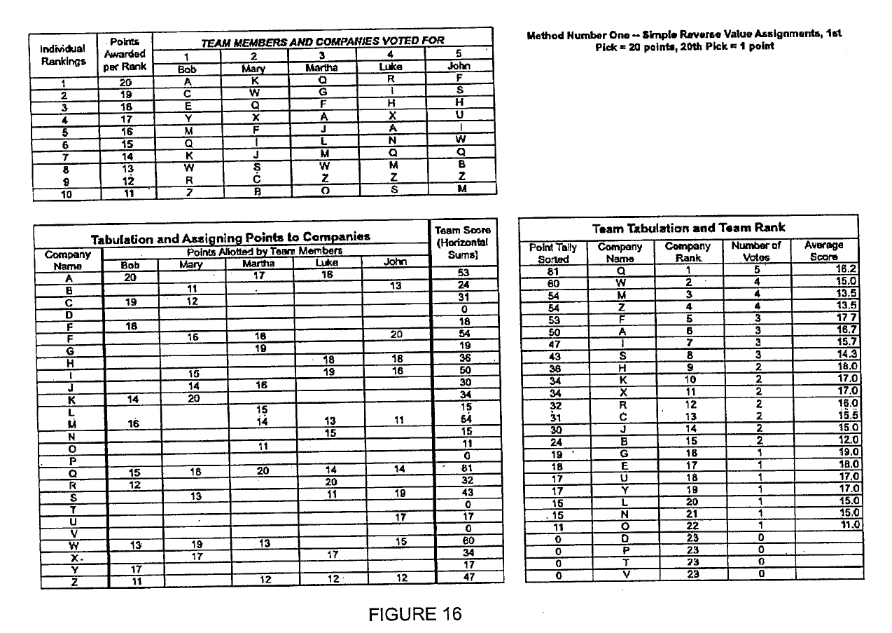

FIG. 16 depicts a spreadsheet 190 that specifies the computation method for calculating the team short list rank from the sum of the team's personal short lists. There is also a method for the charter team member to assign weighting to the votes of each team member to yield a private charter-member view of the team short list, adjusted for the realities of the customer-company's power structure and corporate culture.

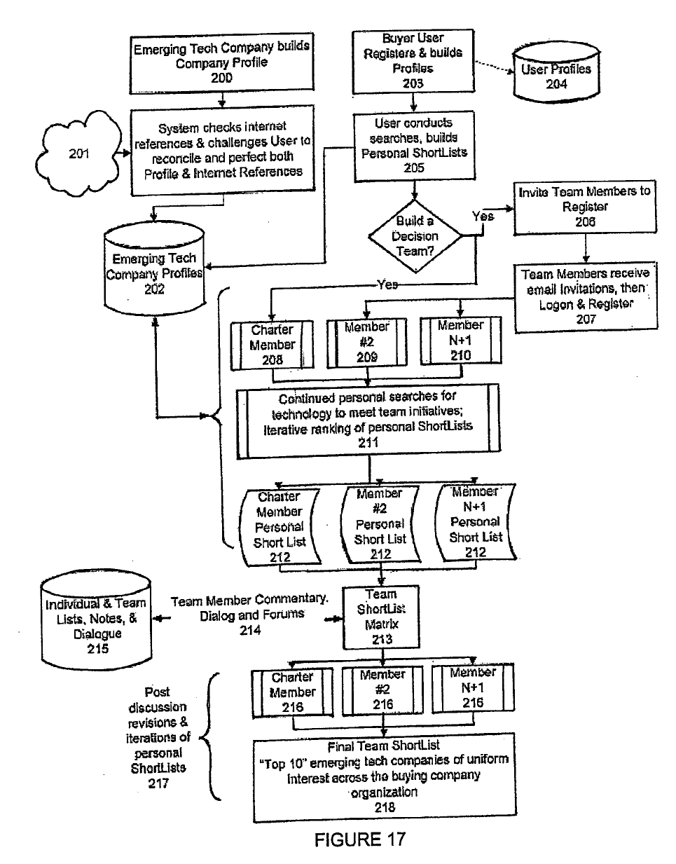

FIG. 17 summarizes, in flowchart form, the activities described up through FIG. 15. The sum of all these activities results in the buying company (or evaluating enterprise) identifying the Top 10 emerging technology companies with the highest degree of shared interest across departments. Of all the emerging technologies, these are the ones most likely to be implemented because the directorates have implicitly agreed to help each other with the implementation. Revealing this consensus represents one of the major motivating forces for use of the invention.

As illustrated in FIG. 17, the selling company registers and builds a company profile which is polished through comparative study 200, 201, 202 and the buying customer user registers and builds his own profile 203, 204. The buyer begins searching and builds personal short lists 205. The first user within a company that decides to create a decision team (the Charter Member) invites others to join 206. These invitees log on, register themselves 207, and become both users and team members 208, 209, 210. The users each begin personal searches to analyze and solve the team problem as defined by the charter member 211, and each user builds and ranks their own personal short lists 212. The personal short lists 212 are then incorporated into the team short list 213 which reveals a team ranking, or team short list 218.

From the team short list view, the team members use virtual communications to share their observations, endorsements, and warnings on each of the short listed companies 214. There are also links to team forums which permit a less structured dialogue on their problem and proposed solution—independent of linkage to any of the emerging tech companies 214. The individual team members can reflect on the work product of the team discussions and elect to modify their individual short lists rankings 216. This is done on a flowing iterative basis until the arbitrary milestone date established by the team for final decision on Top 10 companies 218. All of the proceedings may be stored confidentially within individual and team archives 215.

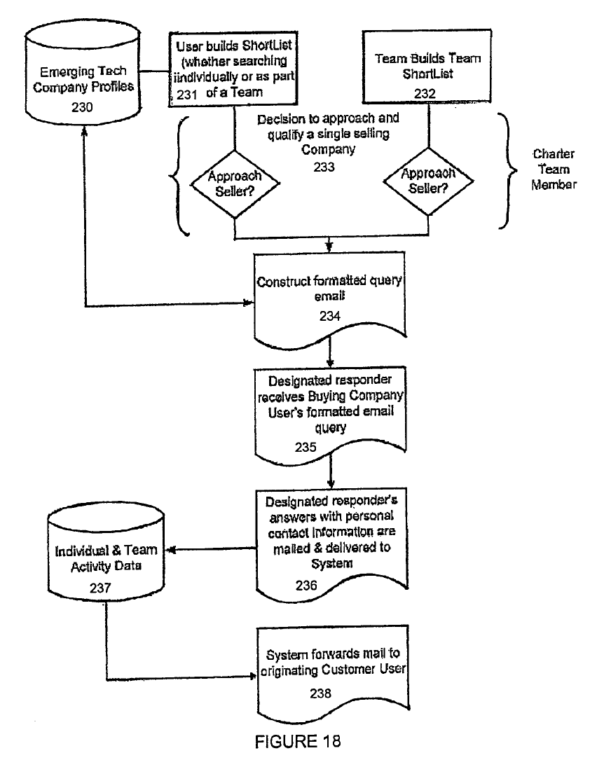

FIG. 18 describes the operation of the “Qualify Yourself” feature. This feature relies on data collected from selling companies (FIG. 18) and buying users (FIG. 1, 10) during their respective registrations. For the selling company, this feature needs to know: who is the “Designated Responder” within the selling company? (FIG. 13) and, what are the top five qualifying questions your sales people generally ask in their first meeting with a prospective customer? (FIG. 13a). At the point a buyer 231, 233 or decision team 232, 233 has determined to move forward to contact with a selling company, the buyer might still wish to economize on effort, and shield himself and his company from direct exposure to the selling company.

The Qualify Yourself feature enables the user to launch an email 234 by selecting a link from within a personal short list or team short list. The email will be sent by the system, anonymously, to the selling company for purposes of requesting that the selling company pre-qualify the opportunity sufficiently to convince the buyer to fully reveal himself—or, in the alternative, to share the opinion that, no, the seller does not think the buyer is a fit for the seller's product. When the buyer sends an email using this feature, the system may ask the buyer to answer qualifying questions 234 stored in the selling company's profile 230 (FIGS. 13a and 13b). The customer's answers to the formatted questions are inserted into the email, along with market segment and other customer profile information that describes the customer, although, the customer may remain anonymous.

The customer can also enter free-form information to describe the problem to be solved and desired solution. This email is then sent to the selling company's designated responder 235, and archived in user data 237. Based on this information received by email, if the selling company believes the customer opportunity is worth pursuing, the selling company logs onto the system, which now helps the seller construct an email in response to the buyer 236. This formatted email may contain the selling company user's direct contact information and the system then notifies the buying-customer user 238. The buyer logs on, reads the selling company response to his queries, and then decides whether to go ahead and pursue contact using the information provided.

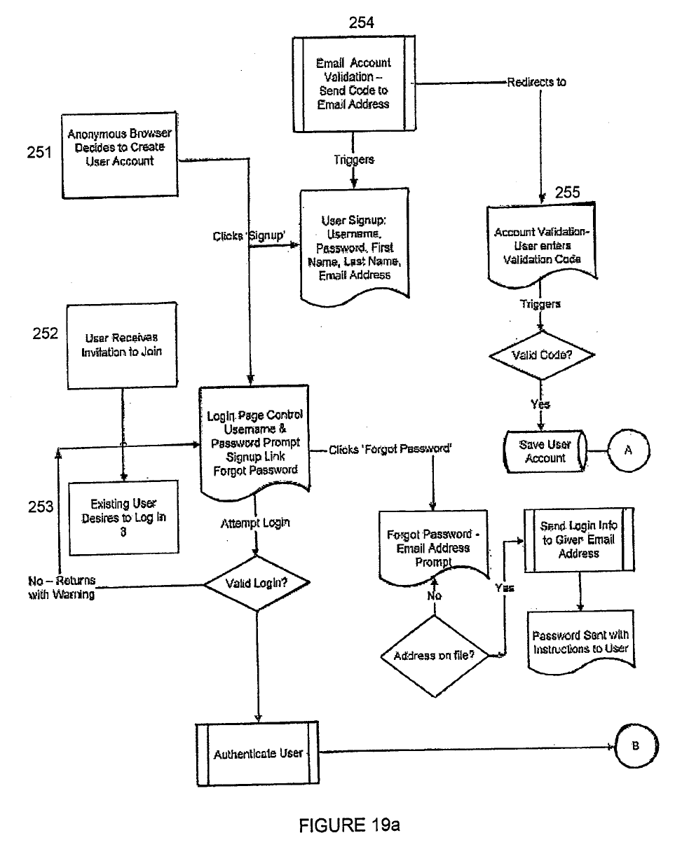

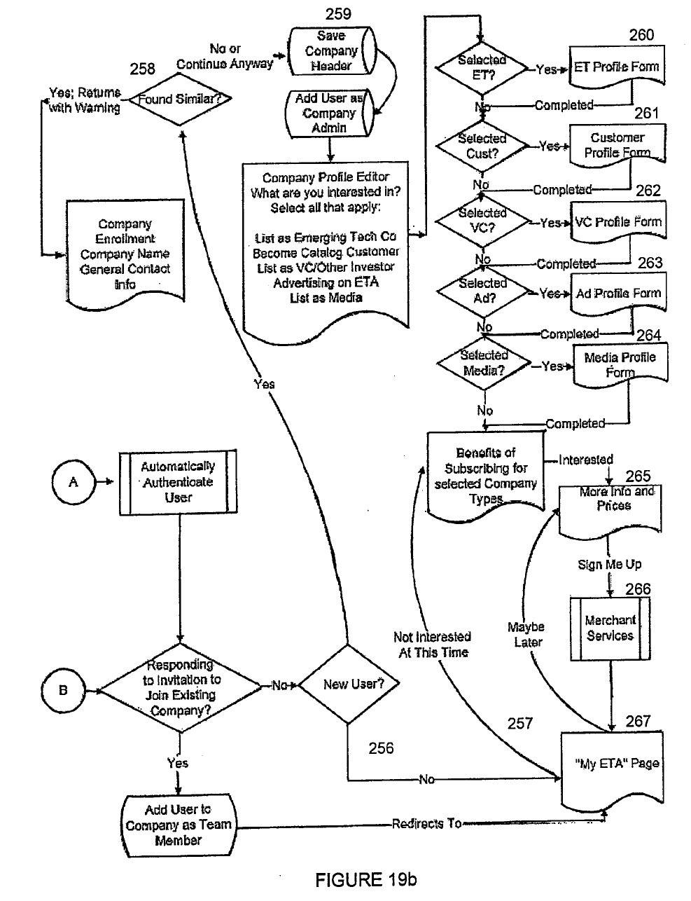

FIGS. 19a and 19b illustrate a split flow chart describing the user registration, login, validation, and entrance process into the system.

FIG. 19a identifies the three primary use cases for a user logging on. The anonymous browser 251 is run through several validations prior to arriving at conclusion of registration (FIG. 19b). The existing user 253 is asked to enter a password and then is directed immediately to a personal system management screen (FIG. 19b, 267). If the existing user forgets the passcode, a routine for sending a new passcode to an email address may be prompted. The third primary use case is the person who has received a system-generated email from an existing user inviting the recipient to join a decision team. The registration routine determines whether this invitation recipient is an existing user or non-user. If the recipient is a non-user, the system directs the recipient to the initial identification and authentication process 254, 255. This process uses return email to validate that the user. The same validation process may be applied to the anonymous browser 251.

In this example and as depicted in FIG. 19b, prior to completion of the registration process for a new user, the system has determined whether the new user type is emerging tech company user 260, buying customer user 261, venture capitalist or other investor 262, a potential advertiser 263, or a member of the media 264. Each user type receives unique “treatments” and tutorials during the registration process, which yields profiles that are uniquely appropriate to each type. These treatments and tutorials correspond to the application software modules identified in FIGS. 1, 19b.

There are corresponding database schemas for the other user types listed above, and each is adapted to the unique characteristics of each user type. These database schemas illustrate the difference in registration treatments for buyers and sellers. For example, a user entering a profile for an emerging tech company product will be asked to identify target market segments for target customers, while the buying-customer user will be asked to identify the market segment values that define itself (as the selling user's target).

As further depicted in FIG. 19b, the new user concludes registration by reviewing various subscription options 265 and paying for a subscription to access the system by credit card 266. The new user is then introduced to his personal system management screen 267 to execute commands and utilize the system.

All new users have their company and business unit names filtered during the profile building process 258. This process then displays the data values already entered for close matches on the values the new user entered. This function allows the community of users from the same business unit of the same company to assign themselves a uniform syntax for the expression of company and business unit. Stylized examples of the dialogue with the user are, “You entered “Ford”. Other's entered “Ford Motor Company”. Which do you really want to use?”

Hardware System Environment:

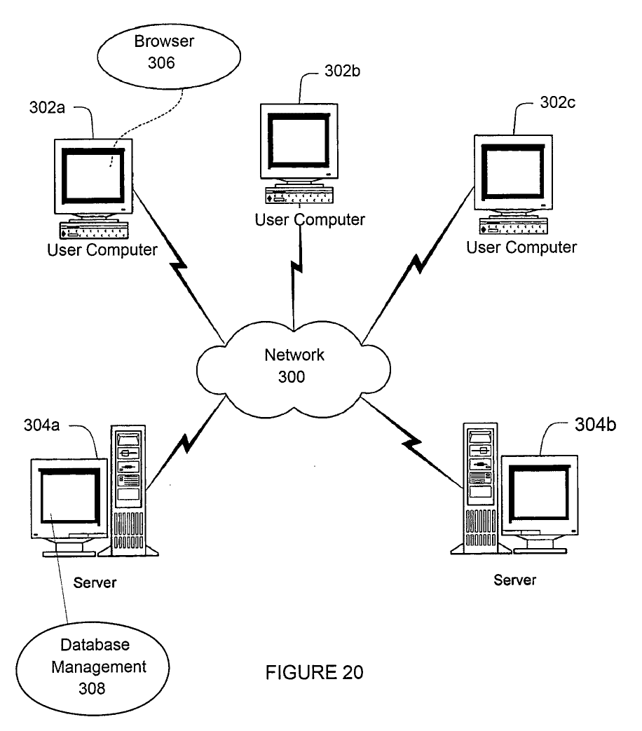

The present invention may be deployed as part of a computer network. In general, the computer network may comprise both server computers and client computers deployed in a network environment. FIG. 20 illustrates an exemplary network environment, with a server in communication with client computers via a network, in which the present invention may be employed.

As shown in FIG. 1, a number of servers 304a, 304b, etc., are interconnected via a communications network 160 (e.g., LAN, WAN, intranet or the Internet) with a number of client computers 302a, 302b, 302c, etc. In a network environment in which the communications network 300 is the Internet, for example, the servers 304 can be Web servers with which the clients 302 communicate via any of a number of known protocols such as hypertext transfer protocol (HTTP). Each client computer 302 can be equipped with a browser 306 or other computer-based application to gain access to the servers 304. Each of the servers may be equipped with database management software 308 or other computer-based systems. In addition to using the network 300 in a client-server configuration, client computer 302a, 302b, 302c may communicate directly with each other in a peer-to-peer configuration.

The present invention is preferably deployed in a network environment, particularly where that network is an Internet or Intranet environment. The Internet can be described as a system of geographically distributed remote computer networks interconnected by computers executing networking protocols that allow users to interact and share information over the networks. Because of such wide-spread information sharing, remote networks such as the Internet have thus far generally evolved into an “open” system for which developers can design software applications for performing specialized operations or services, essentially without restriction.

Thus, the present invention can be utilized in a computer network environment having client computers for accessing and interacting with the network and a server computer for interacting with client computers. However, the systems and methods for providing data transmission in accordance with the present invention can be implemented with a variety of network-based architectures, and thus should not be limited to the example shown.

Example embodiments of the system are described herein with reference to use in the emerging tech companies contexts. In such embodiments, users (preferably multiple) are each provided with at least one (or multiple) computer 302a -302c. Each computer 302a -302c may be connectable to a wide area network 300, such as the Internet.

Depending upon the environment of use, embodiments may also include additional network devices, such as additional computers, connected in the system through the network 300. For example, as part of the data management system 308 (or as a separate element), one or more system personnel, such as customer service operators and/or system administrators may be connected for communication in system, via a computer or other suitable network device. Such system personnel (e.g., System Adminstrator) may be trusted individuals, employed by (or otherwise associated with) an entity administering the system, such that appropriate security and controls may be implemented for system personnel handling or having access to subject information. In some embodiments described above, system personnel may include system administrators or other information technology personnel that may have access to some or all subject information stored on the system, to provide assistance to users.

The computers 302, 304 or other network devices may each include a conventional personal computer (e.g., a desktop or a laptop computer) or other suitable network-connectable communication device having data processing capabilities. For some embodiments with similar functions, the network device may include, but is not limited to, a personal digital assistant (PDA), a mobile telephone, a multimedia mobile telephone (e.g., an iPhone), a convergent wireless device (e.g., a BlackBerry), a pager, or the like. Depending upon the embodiment and environment of use, the computers 302, 304 or other network devices may include or otherwise be associated with a user input device (such as, but not limited to, a keyboard, keypad, mouse, touch screen, optical input device, or the like) and a display device (such as, but not limited to, a cathode-ray tube monitor, an LCD display, an LED display, a plasma display or the like). For convenience and simplification of this disclosure (and without limiting the present invention), embodiments are described herein with reference to the network devices 302, 304 as computers.

The data management component 308 may include software that runs on at least one (or multiple) server(s) connected to the Internet. The system 10 may also include additional system software residing on the computer 304 for interacting with the data management system 308 and providing functions described herein. The software may be stored in a hard disk drive or other suitable computer-readable storage device connected to the user computer(s) 302. The software may be supplied to the respective users by any suitable means, including, but not limited to, computer-readable discs delivered to the user by mail or other form of delivery, or by uploading such software to the user computer 302 from the system, through an Internet connection, for example, during a registration procedure (FIGS. 19a, 19b.) Other system software (not shown) may be provided on the operator or administrator computer(s) 304, for providing similar functions and/or other functions for which the operator or administrator may be authorized to perform. The software for system and the software residing on computers may be configured using any suitable standard or non-standard software coding techniques to provide functions described herein. Alternatively, or in addition, the functions of the computer networked system and/or the user computer 302 described herein may be implemented in suitably configured hardware circuitry or combinations of hardware and software.

In general, the system described may be configured to provide any one or combination of functions to provide an expanded capability to facilitate individual users, as well as groups of such users having, for example, similar personal and/or professional interests or other characteristics.

### Examples of the Benefits of the Invention Over the Prior Art

Prior art for corporate vendor decision making systems addresses the challenge of deciding between two or more alternatives where the customer's problem to be solved is already clearly defined, the category of product or service to be acquired to solve that problem has been narrowly defined, and each member of the team is able to clearly and systematically express their detailed requirements.

An illustrative example might be choosing a car and a car dealer. The prior art may tell someone whether Ford or Chevrolet or Toyota is a better choice. But, either way, the resulting decision will be a car. In contrast, what if someone was speculating what might exist beyond “car”? This person may not know if “beyond car” exists, but would like to find out. And, what if someone had introduced a personal magnetic hovercraft, or Star Trek transporters, or biometric fax machines?This invention enables group visibility and contemplation of a wide range of potential new solutions to known problems or nascent problems. This invention would assist someone in understanding the possibilities for personal locomotion beyond “car”, and then decide, as a group, which of those possibilities merit in-depth examination, and for which of those possibilities a plurality of directorates appears to be willing to do their part to implement a solution. This invention is a decision tool that differs substantially from any decision tool described in prior art.

In the examples described in this disclosure, the invention allows users to work individually, for their own account and as a group with the sum of their technology selections to consolidate, prioritize, and make mutually visible the users progress and analysis.

In the individual user mode, the invention enables A (the customer user) to discover emerging technology sellers B, C, D, E, F, and n+1.

The corporate buyer of emerging technology is likely interested in multiple products and multiple sellers at the same time, because enterprises have many concurrent needs in many departments. In the group or team mode, the invention allows (the customer group) A1, A2, A3, A4, A(n+1) to discover and agree to investigate (emerging technology sellers) B, F, H, R, Q, and n+1. The customer group can maintain as many discreet and separate short lists as necessary to enable searches and discussions to be focused on specific initiatives, as opposed to having all findings for all initiatives coming led within the same list.

The invention additionally enables the Alpha A (the senior executive on the team) to weight the votes of each of his team members so that the consolidated Corporate Top 20 more closely approximates the corporate power and responsibility structure, and the corporate culture.

There is nothing in the prior art on matchmaking that enables members of a group to discover and agree on their findings. There is also no close analog to the invention as it is described above, in the “Decision Tool” filings.

In one embodiment of the invention, the subscribing customer unrestricted access to several thousand emerging technologies representing the portfolios of over 500 venture capitalists, governmental agencies, private equity companies, and the technologies of self-funded start ups. The invention offers several search techniques (described above) so that the user does not need to manually sift through thousands of company profiles, but rather can quickly and easily find technologies of interest.

The invention also makes it easy and practicable for the customer's senior end-user (e.g., executive sponsor) to solicit participation from a large number of cross-departmental influencers and decision makers. This capability optimizes the intrinsic value of the corporate entity because it gives voice to the most knowledgeable subject-matter-experts. And it gives senior management extremely early, and codified visibility to this highest quality corporate thinking.

The disclosed invention is better than the traditional and customary alternatives:
Top Down Edict—where the senior officer makes his own selection and invites other directorates to review, and then approve or disapprove only after emerging technology presenters have incurred travel expense for multiple customer visits and the customer directorates have invested many calendar months and person hours for their own investigations.
Bottoms Up Guerilla Movement—in this case the manager of a single functional unit or business unit has already done discovery and investigation in solitude. He now has a recommendation to make, but is faced with yet another daunting challenge to make allies of his colleague-directorates, educate them on his problem and the proposed solution, and finally secure both their endorsement and their commitment to do their part of implementation.

The invention makes all these agendas visible to all corporate players on the front end, prior to the emerging technology companies being approached, because the invention reveals the companies that represent solutions to problems that all customer directorates acknowledge exist, and for which all directorates already agree in principle to participate in implementing.

The invention enables completion of a critical step to all Global 2000 implementations of emerging technologies. The invention enables immediate, fast, and low-cost rejection of technologies that are not amenable to or implementable by all relevant directorates.

Mutual agreement to implement is prerequisite to implementation. The invention enables systematic and very early dialogue leading to mutual agreement to consider implementation, usually on a basis far more collegial and complete, and dramatically less costly than customary methods.

The invention allows many individual users from the customer company to browse for and find sellers of interest. But, rather than matching a singular customer individual with a single potential technology supplier, the invention facilitates mutual agreement of buyer's individual members a1, a2, a3 etc to investigate emerging technology companies B, C, D, E, F etc. This concept has not been disclosed in the prior art.

Experiment 1: International Consulting Company Proof of Concept Test, Dec. 5, 2008.

Sample Client Problem: Major transportation equipment company has a problem. It currently provides its common carrier customers two completely separate ordering processes for spare parts depending on whether the spares are manufactured by the client company internally, or whether the spares are manufactured by a third party. The client desires the appearance of a uniform ordering process that makes the source transparent to the common carrier customer, and more efficient, without actually altering the underlying reality of where the parts come from and how the parts move physically.

Client Profile: This client is intentional about emerging technologies and has asked explicitly to see solutions that will help it out-perform its competitors by both improving value and reducing costs.

Experiment Method: (A) Compare methods and results for Google search, the invention's catalog search and decision tools, and Intel Capital's Excel spreadsheet; (B) Three consultants participate in the experiment; (C) The consultants must be physically separated and use only non-verbal methods to communicate; (D) 30 minute independent search period for each method, and; (E) A second 30 minute group session to work toward group decision based on the emerging tech company findings yielded by each method.

Non-Realtime Testing Requirement—in a full enterprise use of the invention the 5 or 10 or 50 enterprise users will be building towards a team short list consensus over a period of days or weeks. This means that their team communications must necessarily be non-simultaneous and virtual. The reason the test subjects were instructed not to converse by telephone was to model the real-world conditions under which the invention is used.

TABLE 1
Measureable Results

| | Sum of Potentially | | |
|---|---|---|---|
| | Relevant | Number | |
| | Companies Found | Worthy of | Number that Meet |
| | by 3 Testers in 30 | Further | “Emerging Tech” |
| Method | Minutes | Investigation | Definition |
| Google | 3 | 0 | 0 |
| ET Accelerator | 12 | Top 4, perhaps | 12 |
| | | more | |
| Intel Capital | 0 | 0 | 0 |

The measureable results of this experiment are depicted in Table 1: (A) over a cumulative 90 minutes of effort, 3 well-educated and intentional users were not able to find a relevant emerging tech company using the Google search method; (B) The users reported using between 10 and 20 search arguments each for the Google method, and; (C) Alternatively, the same users were able to find 12 relevant emerging tech companies using the invention using 3 to 5 search arguments.

Using the invention, within less than an additional cumulative 45 minutes (15 minutes each), the 3 users were able to agree on the top 4 companies that merited in-depth investigation on behalf of the client. The zero results for Intel Capital do not reveal any insights regarding the efficacy of searching an Excel spreadsheet. However, it is revealed that Intel Capital is not currently invested in the supply-chain ecosystem, and therefore notwithstanding a portfolio of approximately 400 companies, it currently can offer no emerging technologies for this client's singular problem.

Table 1 further demonstrates that of the 12 relevant companies found using the invention, 10 of them actually could be found after the fact using Google, provided that the Google search argument was the precise syntax of the company's name. In this case, the Google search returned the company's home page URL. This further validates our observation that the emerging techs are “out there”, but just not findable.

TABLE 2
Workflow

| | | |
|---|---|---|
| Emerging Tech | | Intel Capital |
| Accelerator | Google Search | Spreadsheet |

Search

| | | | | | |
|---|---|---|---|---|---|
| Minutes required to find at least | 5 | minutes | 180 | minutes | n/a |
| 4 relevant emerging tech | | | | | |
| companies | | | | | |

Assemble Data

| | | | | | | |
|---|---|---|---|---|---|---|
| Estimated time required to | 0 | minutes | 90 | minutes | 30 | minutes |
| assemble data on 4 “finalists” | | | | | | |
| for consideration by group | | | | | | |

Review and Comment on Group Data

| | | | |
|---|---|---|---|
| Method used | non- | email, links, cut | email, links, cut |
| | simultaneous, | and paste, phone | and paste, phone |
| | on-line | calls | calls |
| | discussion | | |
| Time required | 1 hour | days or weeks | days or weeks |

Publish Prioritized Company Selections

| | | | | |
|---|---|---|---|---|
| push button | 1 | hour | 1 | hour |

Table 2 illustrates the workflow efficiencies of the system as compared to the prior art. The “5 minutes required to find at least 4 relevant emerging tech companies” means that using the invention the consultants were each able to find 1 or 2 relevant companies with their first or second search argument. Even though the Google method did not yield any emerging tech companies, it did yield 3 relevant (established) companies. In order to measure the time that would have been required to reach consensus on companies found within Google, the subjects were asked to proceed during the 2^{nd} 30 minutes of the Google test as if they were sharing results on those 3 companies. Over this next 30 minutes, the consultants cut and pasted and emailed text, or emailed URLs to be studied. The subjects did not succeed in completing enough communication transactions in 30 minutes to even begin movement towards consensus discussions. In Table 2, the times required to review and comment (“1 hour” vs. “days and weeks”) were gathered from the test subjects in a formal written survey. (D) The “push button” reference for time required to publish prioritized selections refers to the invention's method of offering an Excel or similar program download of the team short list.

TABLE 3
Test Subject Verbatims

| Consultant 1 | Consultant 2 |
|---|---|
| Provides directed and on-topic | Site was searchable |
| search results | Ability to tag favorites worked well |
| Information is organized | (Push Pin tool) |
| uniformly in company profiles, | Personal and team ranking of |
| making it easy to pinpoint | companies worked well |
| relevant information | Not sure how viable the search- |
| Companies come from a wide | relevance percentages are |
| range of geographic locations | Team chat forum |
| Comprehensive representation | Decent visibility all the way around |
| of various sectors | Notation abilities on specific |
| Easy to make notes and | companies is good |
| discuss with team | Liked the “prior search” features |
| Direct short list-to-Excel export | Liked the ability to enter companies |
| feature is very useful | that were not in the catalog that I may |
| Also a plus: enables user to add | know of |
| companies that aren't already | Still need to drill down a bit on what |
| included in the catalog (so that the | companies actually do or do not have, |
| Team Tools can include all | make it basic |
| companies under consideration, | Fairly comprehensive |
| and keep them in the same | |
| environment) | |

Table 3 contains verbatim comments added by the test subjects to their survey responses following the test. It is notable that for the most part their subjective observations about the inventions' efficacy and benefits are congruent with those intended by the inventor. It is notable that these test subjects conceived of and reported this large number of congruent observations after having been exposed to the invention for a sum of less than three hours, which three hours included orientation for the test, conducting the test, and reporting their findings on the test.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

I claim:

1. A method of creating a computer-based searchable company database, said method comprising the steps of:
a) having at least one company enter company information using a user interface;
b) creating a company database, wherein said database categorizes said company into a least two tiers of a hierarchical classification system based on the information entered in step a); and
c) permitting users to identify a company of interest based on said hierarchical classification system.

2. The method of claim 1, wherein said computer database includes a computer program comprising computer-executable instructions represented in computer storage.

3. The method of claim 1, wherein said computer database includes a server that provides company information to one or more users of said database.

4. The method of claim 1, wherein said company is an emerging technology company.

5. The method of claim 4, wherein in step b) said hierarchical classification system includes a technology domain classification.

6. The method of claim 5, wherein said company has multiple technology domains.

7. The method of claim 5, wherein said company can make additions to said hierarchical classification system.

8. The method of claim 2, further comprises additional step d) testing the validity of the company information.

9. The method of claim 2, wherein step c) further comprises providing an algorithm that applies two or more search arguments in a single user operation.

10. The method of claim 1, wherein in step c) further permitting identification based on searchable text strings.

11. The method of claim 1, further comprising creating keywords based on the information entered in step a).

12. The method of claim 11, further comprising in step c) permitting said users to identify a company of interest based on said keywords.

13. The method of claim 1, further comprising creating meta data based on the information entered in step a).

14. The method of claim 13, further comprising in step c) permitting said users to identify a company of interest based on said meta data.

15. The method of claim 13, further comprising permitting one or more companies to identify a user of interest based on said meta data.

16. The method of claim 13, further comprising meta data in the form of Global 2000 industry segments.

17. The method of claim 13, wherein the meta data comprises the profession of user.

18. The method of claim 13, wherein the meta data comprises the job title of the user.

19. The method of claim 13, wherein the meta data comprises the description of the corporate department of the user.

20. The method of claim 19, further comprising allowing users to create identifiers based on commonality of commercial interest with at least one of said companies.

21. The method of claim 20, further comprising allowing users to create identifiers based on commonality of commercial interest with at least one other user.

22. The method of claim 20, further comprising creating links between said user and said company based on said identifiers.

23. The method of claim 21, further comprising creating links between said users based on said identifiers.

24. The method of claim 1, further permitting companies to make an anonymous inquiry to other users.

25. The method of claim 20, further permitting companies to make an anonymous inquiry to other users.

26. The method of claim 1, further permitting users to make an anonymous inquiry one or more companies.

27. The method of claim 20, further permitting users to make an anonymous inquiry to one or more companies.

28. The method of claim 1, further permitting users to make an anonymous inquiry to other users.

29. The method of claim 21, further permitting users to make an anonymous inquiry to other users.

30. The method of claim 1, further comprising maintaining a database of internet references of at least one company and making said reference database available to at least one company.

31. The method of claim 1, further comprising maintaining a database of internet references of at least one company and making said reference database available to at least one user.

32. The method of claim 1, further comprising maintaining a database of internet references of at least one user and making said reference database available to at least one company.

33. The method of claim 1, further comprising maintaining a database of internet references of at least one user and making said reference database available to at least one user.

34. The method of claim 30, further comprising providing tools for modifying Wikipedia listings relating to said company.

35. The method of claim 30, further comprising providing tools for modifying Wikipedia listings relating to said user.

36. The method of claim 31, further comprising providing tools for modifying Wikipedia listings relating to said company.

37. The method of claim 31, further comprising providing tools for modifying Wikipedia listings relating to said user.

38. The method of claim 32, further comprising providing tools for modifying Wikipedia listings relating to said company.

39. The method of claim 32, further comprising providing tools for modifying Wikipedia listings relating to said user.

40. The method of claim 33, further comprising providing tools for modifying Wikipedia listings relating to said company.

41. The method of claim 33, further comprising providing tools for modifying Wikipedia listings relating to said user.

42. The method of claim 33, further comprising providing tools for modifying Internet listings relating to said company.

43. The method of claim 33, further comprising providing tools for modifying Internet listings relating to said user.

44. The method of claim 31, further comprising providing tools for modifying Internet listings relating to said company.

45. The method of claim 31, further comprising providing tools for modifying Internet listings relating to said user.

46. The method of claim 32, further comprising providing tools for modifying Internet listings relating to said company.

47. The method of claim 32, further comprising providing tools for modifying Internet listings relating to said user.

48. The method of claim 33, further comprising providing tools for modifying Internet listings relating to said company.

49. The method of claim 33, further comprising providing tools for modifying Internet listings relating to said user

50. The method of claim 1, further providing allowing users to select a company for further investigation.

51. The method of claim 50, further comprising allowing users to create their own categories for archiving information on select companies.

52. The method of claim 51, further comprising allowing users to annotate archived information.

53. The method of claim 52, further comprising allowing users to view the annotated archived information of other users.

54. The method of claim 51, further comprising allowing users to create their own notations to log search activities.

55. The method of claim 51, further comprising allowing users to create their own notations to log collaboration activities.

56. A computer-based system adapted for practicing the method of claim 1.

57. A method of managing a searchable company database, said method comprising the steps of:
a) having at least one listing company to enter company information using a user interface;
b) creating a company profile database based on said listing company information entered in step a);
c) permitting at least one investigating company to access said listing company information;
d) identify at least one listing company as a target company; and
e) establishing a group comprising members of said investigating company for investigation and decision making regarding said target company.

58. The method of claim 57, comprising inducing members of said group to confer with each other via electronic communication.

59. The method of claim 58, wherein said electronic communication is selected from the group consisting of discussion group postings and private email chat.

60. The method of claim 58, wherein said electronic communication includes hyperlinks to target company information.

61. The method of claim 58, wherein said electronic communication includes communication from group members to the group.

62. The method of claim 58, further comprising permitting a user to establish a group of specified individual users.

63. The method of claim 58, further comprising permitting a user to communicate by electronic communication to instruct at least one individual of said group to register and use the invention.

64. The method of claim 63, further comprising permitting an individual user to invite at least one user from a list of users that share an email domain to join a discussion group using electronic communication.

65. The method of claim 61, further comprising permitting an individual user to view a graphic representation representing other users engaged in at least one discussion group and request that at least one user join at least one of the said graphically represented discussion groups.

66. The method of claim 57, further comprising additional step f) compiling a composite group score and method of ranking at least one selection identified by at least one group member.

67. The method of claim 57, further comprising in step e) wherein said electronic communication includes links to user comments.

68. The method of claim 67, wherein said user comments are accessible to other users.

69. The method of claim 66 further comprising permitting users in a discussion group to select a list of one or more companies previously selected, archived and stored for further investigation and discussion.

70. The method of claim 69, further comprising permitting users in a discussion group at least one vote for a one or more companies identified in the selected list forming a new list for each user characterized by priority determined by said vote.

71. The method of claim 70, further comprising permitting all users in the discussion group to view each users' new list based on said priority.

72. The method of claim 71, further comprising permitting one or more users to apply weighted values to the votes of one or more users in said discussion group.

73. The method of claim 72, further comprising permitting one or more users to apply a final discretionary prioritization to the selected list.

74. A computer-based system adapted to practice the method of claim 57.
